(19) United States
(12) Patent Application Publication
(10) Pub. No.: US 2005/0206913 A1
(43) Pub. Date: Sep. 22, 2005

(54) Image forming apparatus, job managing method, electronic device, job displaying method, and job displaying program

(76) Inventors: Toru Matsuda, Kanagawa (JP); Hisanori Takahashi, Chiba (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/072,593

(22) Filed: Mar. 7, 2005

(30) Foreign Application Priority Data
Mar. 8, 2004 (JP) 2004-064048
Mar. 8, 2004 (JP) 2004-064049
Mar. 2, 2005 (JP) 2005-057889
Mar. 2, 2005 (JP) 2005-057890

(51) Int. Cl. G06F 15/00

(52) U.S. Cl. 358/1.1; 358/1.14

(57) ABSTRACT

In an image forming apparatus, job related information showing a relationship between one job and each of other jobs, is generated for each job. Job structure information to search for a certain job related to an arbitrary job is created based on the job related information.

### BACKGROUND OF THE INVENTION

1. Field of the Invention

The present invention generally relates to image forming apparatuses, job managing methods, electronic devices, job displaying methods, and job display programs for causing a computer to execute a job display.

2. Description of the Related Art

Recently, an image forming apparatus, which accommodates various functions to serve as devices such as a facsimile, a printer, a copier, and a scanner in a single chassis, has been widely used. In addition to providing a display part, a printing part, and an imaging part within the single chassis, the image forming apparatus includes four applications corresponding to the facsimile, the printer, the copier, and the scanner, respectively. By switching these applications, the image forming apparatus operates as the facsimile, the printer, the copier, and the scanner.

Each of processes concerning an image formation such as an image output, an image modification, and an image moving operation is executed by a process unit as a job. For example, in a case of conducting a copy, since a process for reading an original and a process for printing the original being read are conducted, an original read job and a print job are generated in the image forming apparatus. As a case in that these jobs are not generated, there is a case of changing settings of the image forming apparatus. In this case, since any process concerning an image is not conducted, no job is generated.

A job being originally generated can be divided into detailed jobs during the process. This will be described with reference to FIG. 1. For example, in a case of conducting a copy, in the image forming apparatus, first, “copy job” is generated. Then, this “copy job” generates two descendent jobs: a “read job” and a “print job”. As described above, in a case in that one job generates another new descendent job, a former is called a “parent job” and a latter is called a “child job”.

The job is called the parent job or the child job, which may be considered to simultaneously exist together. However, conventionally, when the child job is generated, the parent job is deleted. In the above example, when “read job” and “print job” are generated from “copy job”, “copy job” is deleted. Accordingly, in a conventional job generation, a parent job breaks and becomes a child job.

In the copy job described above, one child job is generated from the copy job. The copy job may generate a plurality of child jobs based on a process. For example, as shown in FIG. 2, in a case of printing a document mixing a color page and a black and white page, the color page and the black and white page may be separately processed by different processes to be printed out.

First, when the image forming apparatus receives a request from a user, the “print job” is generated. Then, the “print job” generates a “color print job” and a “black and white print job”. Moreover, a “plotter job” is generated for each unit of pages to be printed.

As this generation is shown in FIG. 2, this generation forms a job structure. In this job structure, a job at a root is called a “root job”, and a job at the end of the job structure is called an “end job”. In the job structure in FIG. 2, the root job is a print job, and the end job is a plotter job. Conventionally, once the root job is processed in a spool, the root job is deleted.

Moreover, in the conventional job management, each application has a respective queue for the root job, and manages an order to process jobs. For example, as shown in FIG. 3, a printer application being an application for the printer manages the order such as a root job A, a root job B, a root job C, . . . queued in a root job queue for the printer application.

Furthermore, the end job with respect to hardware such as the plotter has a special queue, and an order to process jobs is managed by using the special queue. For example, as shown in FIG. 4, a module in a service layer managing jobs of each application and each end job manages the order such as an end job A, an end job B, an end job C, . . . queued in a queue for the plotter job.

The module managing the jobs obtains job information by accessing the queue of the module, and sends the job information to an application activating in the personal computer, so that the application can display a user interface as shown in FIG. 5. The conventional user interface shown in FIG. 5 displays the root jobs. Accordingly, the user managing the jobs can see a state of each job by referring to this display. Moreover, once the root job is processed in the spool, the root job is deleted. As a result, the user interface does not show the root job any longer.

As described above, conventionally, the root job is deleted after the root job is processed in the spool. Thus, it is impossible to recognize from which parent job a child job is generated. Thus, for example, when an error occurs at an end job, it cannot be recognized which request causes the error. Moreover, even if the user attempts to cancel a root job generated in response to a request while the root job is being processed, since the child job generated from the root job cannot be canceled, the user cannot cancel the process related to the root job.

Moreover, conventionally, jobs are not sufficiently managed. Thus, it is not sufficiently conducted to obtain information concerning each job and to operate each job.

### SUMMARY OF THE INVENTION

It is a general object of the present invention to provide image forming apparatuses, job managing methods, electronic devices, job displaying methods, and job displaying programs for causing a computer to execute a job display in which the above-mentioned problems are eliminated.

A more specific object of the present invention is to provide an image forming apparatus, a job managing method, an electronic device, a job displaying method, and a job displaying program for causing a computer to execute a job display, which provide a user interface preferable for a job management of an image forming process.

The above objects of the present invention are achieved by an image forming apparatus including a hardware resource used in an image forming process, and executing a job concerning an image formation, the image forming apparatus including: a job related information generating part generating job related information showing a relationship between one job and each of other jobs, for each job; and a job structure information creating part creating job structure information to search for a certain job related to an arbitrary job based on the job related information.

The above objects of the present invention are achieved by a job managing method for managing a job in an image forming apparatus including a hardware resource used in an image forming process, and executing a job concerning an image formation, the job managing method including: generating job related information to create job structure information of the job; and creating the job structure information based on the job related information.

The above objects of the present invention are achieved by an electronic device for displaying job information concerning a job generated in a predetermined process, the electronic device including: job structure information showing a relationship between an arbitrary job and each of other job; and a graphical user interface displaying part displaying the job information based on the job structure information.

The above objects of the present invention are achieved by a job displaying method for displaying job information concerning a job generated in a predetermined process, the job displaying method including: receiving job structure information showing a relationship between an arbitrary job and each of other job; and displaying the job information based on the job structure information.

The above objects of the present invention are achieved by a job displaying program for causing a computer to display job information concerning a job generated in a predetermined process, the job displaying program comprising the code for: receiving job structure information showing a relationship between an arbitrary job and each of other job; and displaying the job information based on the job structure information.

### BRIEF DESCRIPTION OF THE DRAWINGS

In the following, embodiments of the present invention will be described with reference to the accompanying drawings.

FIG. 1 is a diagram showing conventional job derivation;

FIG. 2 is a diagram showing the conventional job derivation in a case of printing out a document mixing a color page and a black and white page;

FIG. 3 is a diagram showing a conventional job management in a printer application;

FIG. 4 is a diagram showing the conventional job management in a module in a service layer;

FIG. 5 is a diagram showing a conventional user interface;

FIG. 6 is a diagram showing a job state transition according to an embodiment of the present invention;

FIG. 7 is a diagram showing children job descending from a root job, according to the embodiment of the present invention;

FIG. 8 is a diagram showing a case in that another job is generated from one job, according to the embodiment of the present invention;

FIG. 9 is a diagram showing a case in that a plurality of jobs are generated from one job, according to the embodiment of the present invention;

FIG. 10 is a diagram showing a job structure in a plurality of MFPs according to the embodiment of the present invention;

FIG. 11 is a diagram showing generation of a job by transferring a process according to the embodiment of the present invention;

FIG. 12 is a diagram showing derivation of a job by dividing the process according to the embodiment of the present invention;

FIG. 13 is a diagram showing the derivation of the job by dividing the process according to the embodiment of the present invention;

FIG. 14 is a diagram showing the derivation of the job according to the embodiment of the present invention;

FIG. 15 is a diagram showing an implementation of a single process and a single thread according to the embodiment of the present invention;

FIG. 16 is a diagram showing an implementation of a single process and multi-threads according to the embodiment of the present invention;

FIG. 17 is a diagram showing an implementation of a multi-processes and a single thread according to the embodiment of the present invention;

FIG. 18 is a diagram showing an implementation of a multi-processes and multi-threads according to the embodiment of the present invention;

FIG. 19 is a diagram showing an implementation of an operation for a job by a user, according to the embodiment of the present invention;

FIG. 20 is a diagram showing job information according to the embodiment of the present invention;

FIG. 21 is a diagram showing the job information according to the embodiment of the present invention;

FIG. 22 is a diagram showing an example of permission information of an operation of a job, according to the embodiment of the present invention;

FIG. 23 is a diagram showing an example of a condition to allow an operation for the job, according to the embodiment of the present invention;

FIG. 24 is a diagram showing a job structure table according to the embodiment of the present invention;

FIG. 25 is a diagram showing a job structure table described in XML according to the embodiment of the present invention;

FIG. 26 is a diagram showing a job generated in a copy accumulation process, according to the embodiment of the present invention;

FIG. 27 is a block diagram showing a software structure of the MFP according to the embodiment of the present invention;

FIG. 28 is a block diagram showing a hardware configuration of the MFP according to the embodiment of the present invention;

FIG. 29 is a diagram showing a relationship in software of the MFP according to the embodiment of the present invention;

FIG. 30 is a diagram showing the relationship in the software of the MFP according to the embodiment of the present invention;

FIG. 31 is a diagram showing a job structure according to the embodiment of the present invention;

FIG. 32 is a diagram showing a first example of the job related information according to the embodiment of the present invention;

FIG. 33 is a diagram showing the job information in the first example of the job related information according to the embodiment of the present invention;

FIG. 34 is a diagram showing an operation sequence flow when a job is registered in the first example of the job related information according to the embodiment of the present invention;

FIG. 35 is a diagram showing an operation sequence flow when a job is referred to in the first example of the job related information according to the embodiment of the present invention;

FIG. 36 is a diagram showing a second example of the job related information according to the embodiment of the present invention;

FIG. 37 is a diagram showing the job information in the second example of the job related information according to the embodiment of the present invention;

FIG. 38 is a diagram showing an operation sequence flow when a job is registered in the second example of the job related information according to the embodiment of the present invention;

FIG. 39 is a diagram showing an operation sequence flow when a job is referred to in the second example of the job related information according to the embodiment of the present invention;

FIG. 40 is a diagram showing a third example of the job related information according to the embodiment of the present invention;

FIG. 41 is a diagram showing the job information in the third example of the job related information according to the embodiment of the present invention;

FIG. 42 is a diagram showing an operation sequence flow when a job is registered in the third example of the job related information according to the embodiment of the present invention;

FIG. 43 is a diagram showing an operation sequence flow when the job is referred to in the third example of the job related information according to the embodiment of the present invention;

FIG. 44 is a diagram showing a fourth example of the job related information according to the embodiment of the present invention;

FIG. 45 is a diagram showing the job information in the fourth example of the job related information according to the embodiment of the present invention;

FIG. 46 is a diagram showing an operation sequence flow when a job is referred to in the fourth example of the job related information according to the embodiment of the present invention;

FIG. 47 is a diagram showing a fifth example of the job related information according to the embodiment of the present invention;

FIG. 48 is a diagram showing the job information in the fifth example of the job related information according to the embodiment of the present invention;

FIG. 49 is a diagram showing an operation sequence flow when a job is registered in the fifth example of the job related information according to the embodiment of the present invention;

FIG. 50 is a diagram showing a sixth example of the job related information according to the embodiment of the present invention;

FIG. 51 is a diagram showing the job information in the sixth example of the job related information according to the embodiment of the present invention;

FIG. 52 is a diagram showing an operation sequence flow when a job is registered in the sixth example of the job related information according to the embodiment of the present invention;

FIG. 53 is a diagram showing a seventh example of the job related information according to the embodiment of the present invention;

FIG. 54 is a diagram showing an operation sequence flow when a job is registered in the seventh example of the job related information according to the embodiment of the present invention;

FIG. 55 is a diagram showing an operation sequence flow when the job is referred to in the seventh example of the job related information according to the embodiment of the present invention;

FIG. 56 is a diagram showing an operation sequence flow when a job is registered in a configuration shown in FIG. 30, according to the embodiment of the present invention;

FIG. 57 is a diagram showing an operation sequence flow when the job is referred to in the configuration shown in FIG. 30, according to the embodiment of the present invention;

FIG. 58 is a diagram showing a sequence flow of processes in a case of canceling a job, according to the embodiment of the present invention;

FIG. 59 is a diagram showing a sequence flow of processes in a case of re-executing a job, according to the embodiment of the present invention;

FIG. 60 is a diagram showing a user interface according to the embodiment of the present invention;

FIG. 61 is a diagram showing the user interface according to the embodiment of the present invention;

FIG. 62 is a diagram showing an error occurrence according to the embodiment of the present invention;

FIG. 63 is a diagram showing a display of a menu according to the embodiment of the present invention;

FIG. 64 is a diagram showing a cancel of a job, according to the embodiment of the present invention;

FIG. 65 is a diagram showing the error occurrence according to the embodiment of the present invention;

FIG. 66 is a diagram showing the job information according to the embodiment of the present invention;

FIG. 67 is a diagram showing a cancel of a job, according to the embodiment of the present invention;

FIG. 68 is a diagram showing a disappearance of a canceled job, according to the embodiment of the present invention;

FIG. 69 is a diagram showing cooperation of MFPs according to the embodiment of the present invention;

FIG. 70 is a diagram showing a network configuration including two MFPs and a job management server according to the embodiment of the present invention;

FIG. 71 is a diagram showing a management screen displayed at the job management server according to the embodiment of the present invention;

FIG. 72 is a diagram showing a job structure of a MFP A according to the embodiment of the present invention;

FIG. 73 is a diagram showing a state in that an icon representing a job is dragged, according to the embodiment of the present invention;

FIG. 74 is a diagram showing a state in that a dragged job becomes a job of another MFP according to the embodiment of the present invention;

FIG. 75 is a diagram showing a display only for a root job, according to the embodiment of the present invention;

FIG. 76 is a diagram showing a display only for an end job, according to the embodiment of the present invention;

FIG. 77 is a diagram showing a display for a job list showing all jobs, according to the embodiment of the present invention;

FIG. 78 is a diagram showing a search condition screen according to the embodiment of the present invention; and

FIG. 79 is a diagram showing a search result according to the embodiment of the present invention.

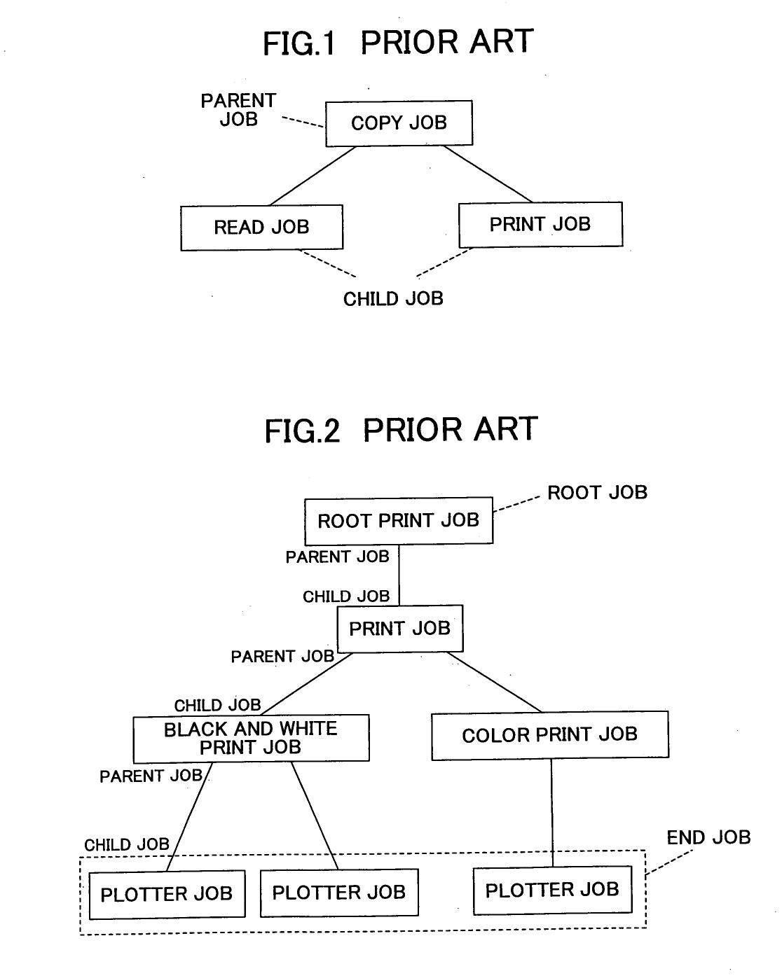

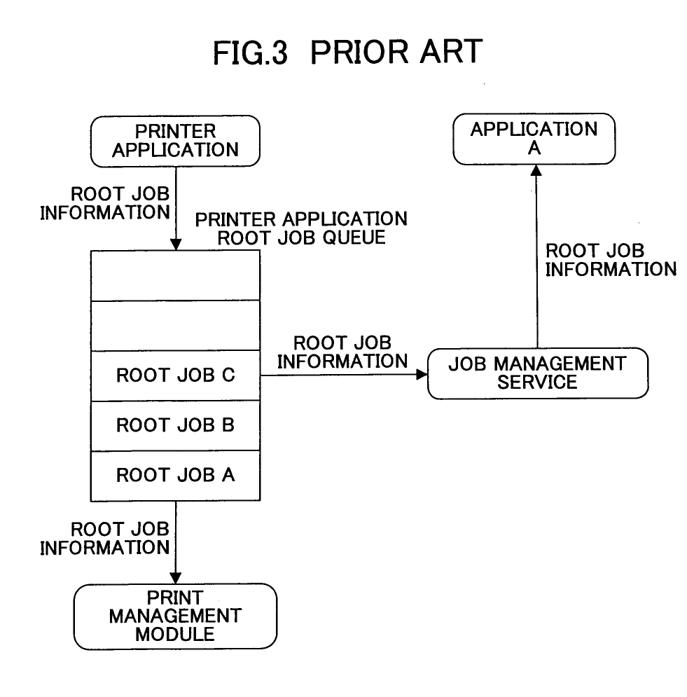

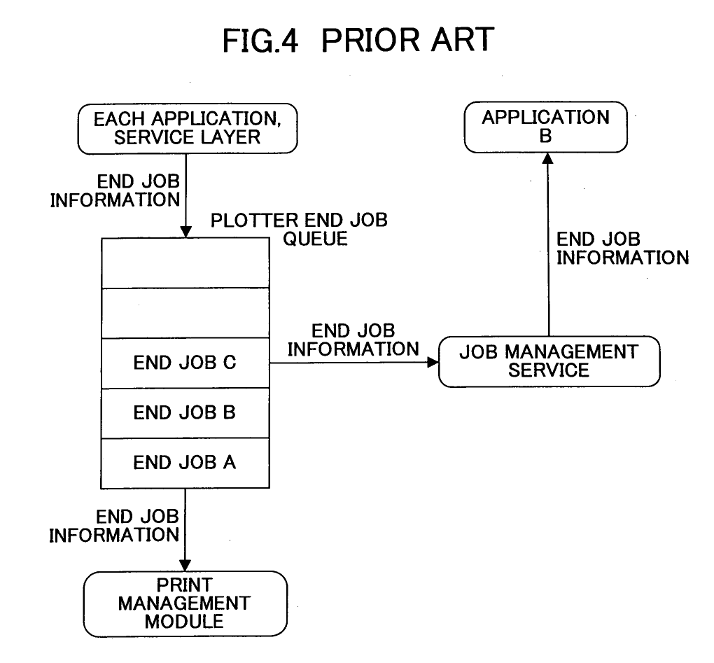

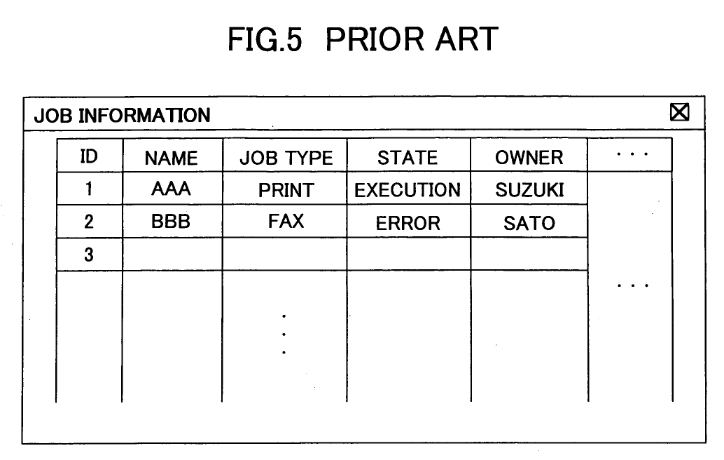

### DESCRIPTION OF THE PREFERRED EMBODIMENT

In the following, an embodiment of the present invention will be described with reference to the accompanying drawings. In the embodiment of the present invention, first, a process according to the present invention will be briefly described, and then, the process will be described in detail including a user interface. In the embodiment, an electronic device is described as an MFP (Multi-Function Printer). It should be noted that not only the MFP displays job information but also a personal computer connecting to the MFP displays the job information.

First, the process according to the present invention will be described. Since there are many contents concerning a job in the embodiment, first, operations with respect to the job and a state of the job will be described. The operations with respect to the job includes a “cancel job”, an “interrupt job”, a “re-execute job”, an “edit job information”, and “change device to execute job”.

An operation of the “cancel job” is an operation to cancel an execution of the job. The operation of the “cancel job” can be conducted to the job having a job state, which shows one of an “execution”, an “error occurrence”, a “waiting”, and an “interruption”. Once the job is canceled, the job will not be executed again.

An operation of the “interrupt job” is an operation to temporarily stop an execution of the job. The operation of the “interrupt job” can be conducted with respect to a job having the job state showing the “execution” or the “waiting”.

An operation of the “re-execute job” is an operation to re-execute a job having the job state showing the “error occurrence” or the “interruption”. In a case in that another job is being executed when the job is re-executed, and the job cannot be immediately re-executed, the job state of the job becomes the “waiting”.

An operation of the “edit job information” is an operation to edit a condition of an execution of the job. For example, an operation for changing a destination of a facsimile transmission to another destination can be the operation of the “edit job information”. The operation of the “edit job information” is conducted with respect to the job having the job state showing the “error occurrence”, the “waiting”, or the “interruption”.

An operation of the “change device to execute job” is an operation to change a device to execute the job. For example, in a case in that two MFPs are installed and selectively usable, an operation to execute a print by using another MFP, instead of a current MFP to print out, is the operation of the “change device to execute job”.

Next, the job state will be described. As the job state, there are an “execution”, an “error occurrence”, an “interruption”, an “end”, and a “cancel”.

The “execution” shows the job state in that the job is being executed. The “waiting” shows the job state in that a job is waiting to be executed. In this job state, the job has a turn of being executed, the job state is changed to be the “execution”. The “error occurrence” shows the job state in that an error occurs during the execution of the job and the job cannot be executed. In this job state, when the error is overcome, the execution of the job is resumed, and the job state becomes the “execution”.

The “interruption” is the job state in that the execution of the job is temporarily stopped by an operation of the user. The “end” is the job state in that the job normally ends. The “cancel” is the job state in that the execution of the job is cancelled by an operation of the user.

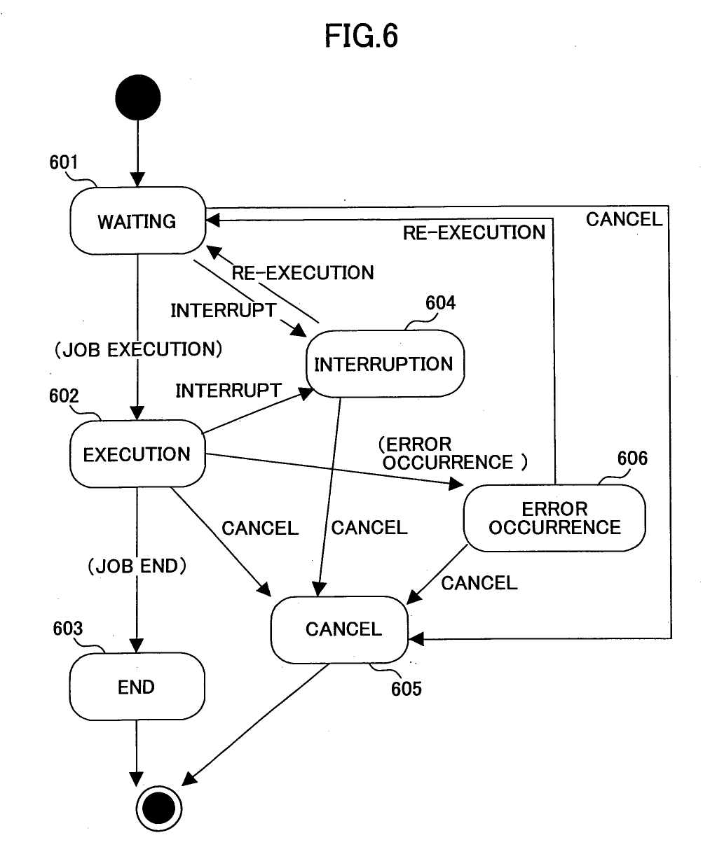

Next, a job state transition will be described with reference to FIG. 6. In FIG. 6, the job states and events are shown, and each job state transition by the event is shown. The events include six events such as an execution of a job, an end of a job, a re-execution, an interruption, an error occurrence, and a cancel. Of these six executions, the execution of a job, the end of a job, and the error occurrence are internal events.

Basically, in a case in that an event is cancelled, the job state transits to a cancel 605, regardless of a current job state, and then the job is terminated. In a case in that the event is re-executed, the job state transits toward a waiting 601, regardless of the current job state.

In general, the job state transits from the waiting 601 to an execution 602, and then an end 603. When the job state is the waiting 601, the job state transits to the execution 602 when the job is executed.

When the job state is the execution 602, the job state transits in response to any one of an interruption event, an error occurrence event, and a cancel event. First, when the event is the interruption event, the job state transits to an interruption 604. When the even is an error occurrence event, the job state transits to an error occurrence 606.

When the job state is the interruption 604, the job state transits in response to a re-execution event or a cancel event. When the job state is the error occurrence, the job state transits in response to the re-execution event or the cancel event.

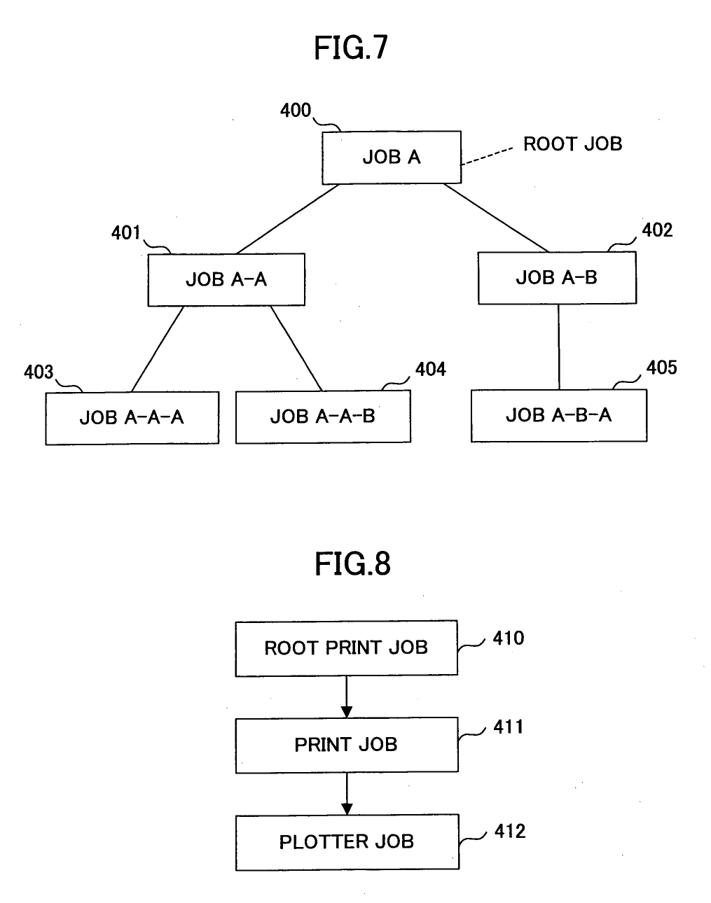

The job state transition has been described above. Next, a job generation will be described. FIG. 7 is a diagram showing a case in that the children jobs are generated from the root job. A relationship among jobs as shown in FIG. 7 is called a job structure, information showing the job structure is called job structure information. The job structure information is described as a job structure table in the present invention, and the job structure table will be described later.

In a conventional technology, since the root job is deleted once the root job is process in a spool, a parent-child relationship between the root job and each child job generated from the root job is not maintained. In the present invention, the parent-child relationship can be maintained without being deleted until all children jobs generated from each parent job are processed.

For example, in FIG. 7, in the conventional technology, a job A 400 is deleted after a job A-A 401 and a job A-B 402 are generated from the job A 400. As a result, a job structure as shown in FIG. 7 cannot be recognized in the MFP. However, in the present invention, the job A 400 is maintained until the job A-A 401 and the job A-B 402 as children jobs of the job A 400 are processed. Moreover, the job A-A 401 is maintained until a job A-A-A 403 and a job A-A-B 404 as children jobs of the job A-A 401 are processed. Furthermore, the job A-B 402 is maintained until a job A-B-A 405 as a child job of the job A-B 402 is processed. Accordingly, the job structure shown in FIG. 7 can be built in the MFP.

Next, a job generation pattern will be described. FIG. 8 is a diagram showing the job generation pattern to generate from one job to another job. In FIG. 8, one print job 411 is generated from one root print job 410, and one plotter job 412 is generated from the print job 411.

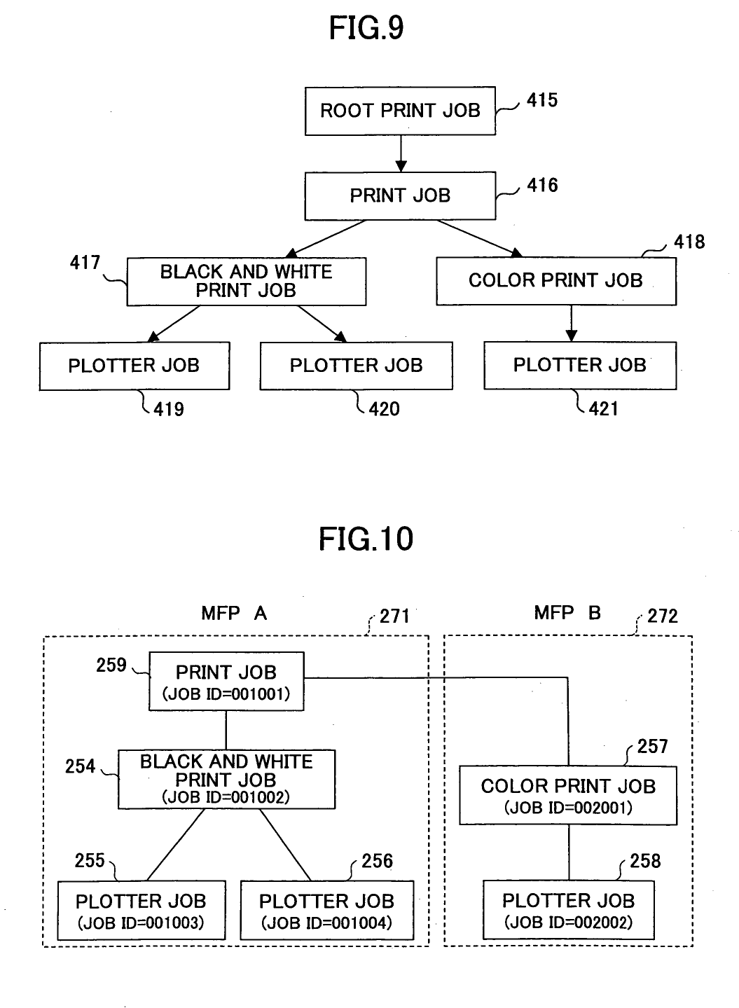

Next, referring to FIG. 9, the job generation pattern in that a plurality jobs are generated from a single job will be described. In FIG. 9, one print job 416 is generated from one root print job 415, and a black and white print job 417 and a color print job 418 as two children jobs are generated from the print job 416. In addition, two plotter jobs 419 and 420 are generated from the black and white print job 417. Moreover, another plotter job 421 is generated from the color print job 418.

Next, the job structure in a case in that a plurality of MFPs are associated with each other will be described. FIG. 10 is a diagram showing the job structure in a case in that two MFPs are associated with each other. In FIG. 10, a job structure 271 concerning jobs executed by an MFP A and a job structure 272 concerning jobs executed by an MFP B are shown.

The job structure 271 shows a print job 259 as the root job, a black and white print job 254, and plotter jobs 255 and 256. The job structure 272 shows a color print job 257, and a plotter job 258.

As described above, the black and white print job 254 generated from the print job 259 is assigned to the MFP A, and the color print job 257 similarly generated from the print job 259 is assigned to the MFP B, so as to realize a job assignment.

In FIG. 10, a job ID is indicated to specify a job. Each job ID is uniquely assigned to each of jobs shown in the entire job structures 271 and 272.

This job ID is formed by six bits in that upper three bits are used as an identification code to identify the MFP, and lower three bits are used to show an unique value in all jobs in the MFP. In practice, in FIG. 10, the identification code of the MFP A is “001”, and the identification code of the MFP B is “002”. Moreover, the lower three bits in each job ID of jobs belonging to each job structure show a unique value in the jobs in each of the MFP A and MFP B.

As described above, there are two job generation patterns. One job generation pattern is a pattern of generating one job from a single job, and another job generation pattern is a pattern of generating a plurality of jobs from a single job.

Next, conditions to generate a job will be described. One condition to generate another job from one job is a case in that another job is generated by transferring a process, and another condition to generate another job from one job is a case in that another job is generated to divide and manage a process.

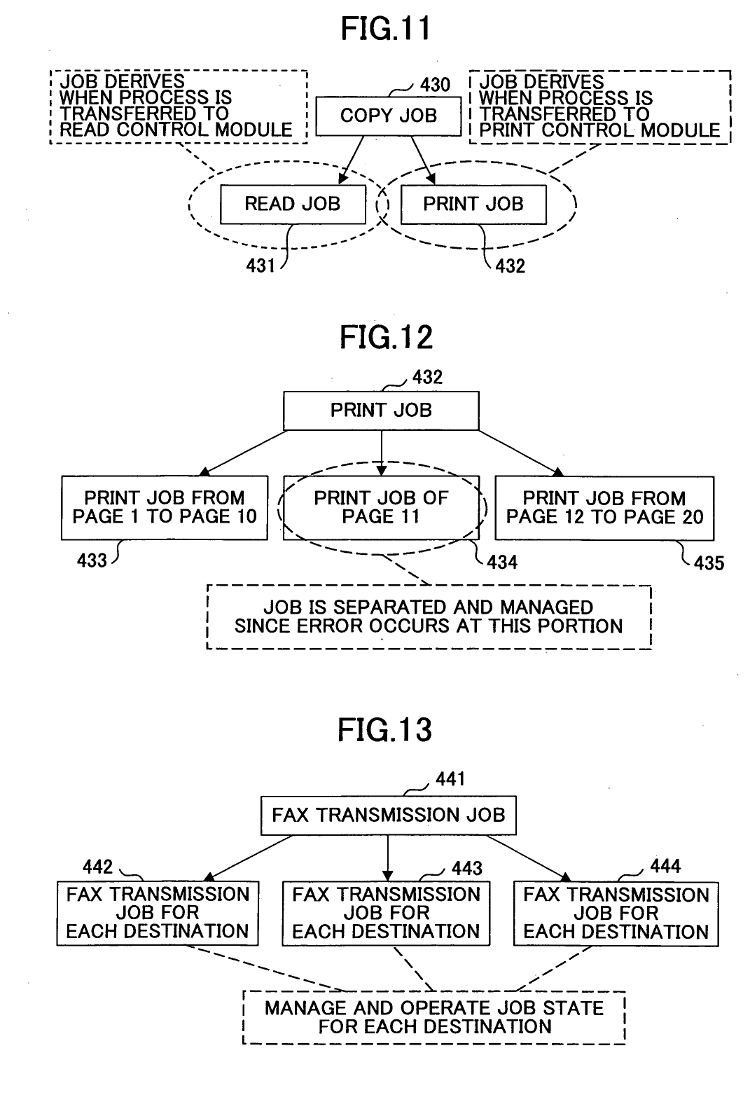

First, referring to FIG. 11, the case in that another job is generated by transferring the process will be described. In order to carry out an own job of software, a part of the process is transferred to other software. A job is generated by this process transfer.

FIG. 11 illustrates an example in that by transferring a part of a process of a copy job 430 to a read control module, a read job 431 is generated, and by further transferring to a print control module, a print job 432 is generated.

Next, referring to FIG. 12, a case of generating another job in order to divide and manage a process will be described. A process is divided and managed, in order to manage a part of a job separately from the job itself. Another job is generated by this job division. FIG. 12 illustrates an example in that since an error occurs a part of the print job 432 conducting a process, the part is separated from normal jobs 433 and 435, which are generated from the print job 432, to generate another job 434. Also, the part is individually managed the job state (execution or error occurrence), and operated (re-execution or cancel).

Referring to FIG. 13, another example of generating a job by dividing a process will be described. FIG. 13 illustrates an example in that when the same document is sent by facsimile to a plurality of destinations, the job state of a FAX transmission job 441 is managed and operated as FAX transmission jobs 442, 443, and 444.

The job generation has been described above. As described above, the job in the embodiment can be a print process, a plotter process, a black and white print process, a color print process, a read process, a per-page print process, or a fax transmission process for each destination. However, these processes are simply exampled, and the jobs are not limited to these processes but the jobs can be other processes. The present invention can have advantages of charging a payment for each job in addition of canceling and operating a job and a generated job, by managing each of generated jobs as described above.

Next, a method for software to process a job is different based on an implementation method. The implementation method will be described.

In this embodiment, a case of implementing by a single process and a single thread, a case of implementing by a single process and multi-threads, a case of implementing by multi-processes and a single thread, and a case of implementing by multi-processes and multi-threads will be described.

In addition, in this embodiment, implementations of operations such as the re-execution and cancel of a job by the user will be described. In the single process and the multi-threads, the single process is used but the single process includes multi-threads. Also, in the multi-processes and the single thread, multi-processes are used but each process has only a single thread.

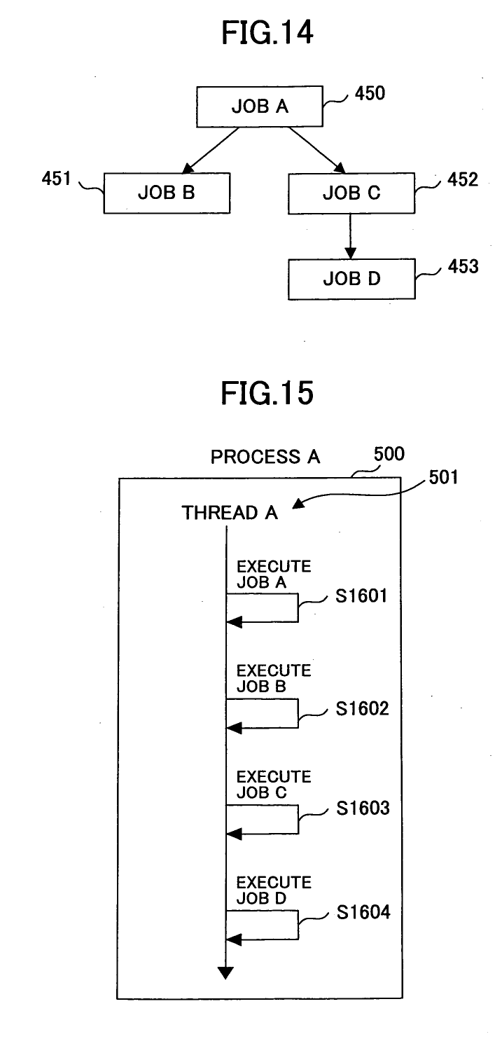

The job structure of jobs used in the above cases will be described with reference to FIG. 14. In FIG. 14, during the process, a job B 451 and a job C 452 are generated from a job A 450, and a job D 453 is generated from the job C 452.

First, referring FIG. 15, a job process in the case of the single process and the single thread will be described. In FIG. 15, a process A 500 and a thread A 501 are shown. This software has a single process (process A 500), and the single process has a single thread (thread A 501). In this case, the job A 450, is executed in step S1601. The job B 451 is executed in step S1602. The job C 452 is executed in step S1603. The job D is executed in step S1604.

As described above, in the case of the single process and the single thread as shown in FIG. 15, all of the jobs, the job A 450 through the job D 453, are processed by the thread A 501.

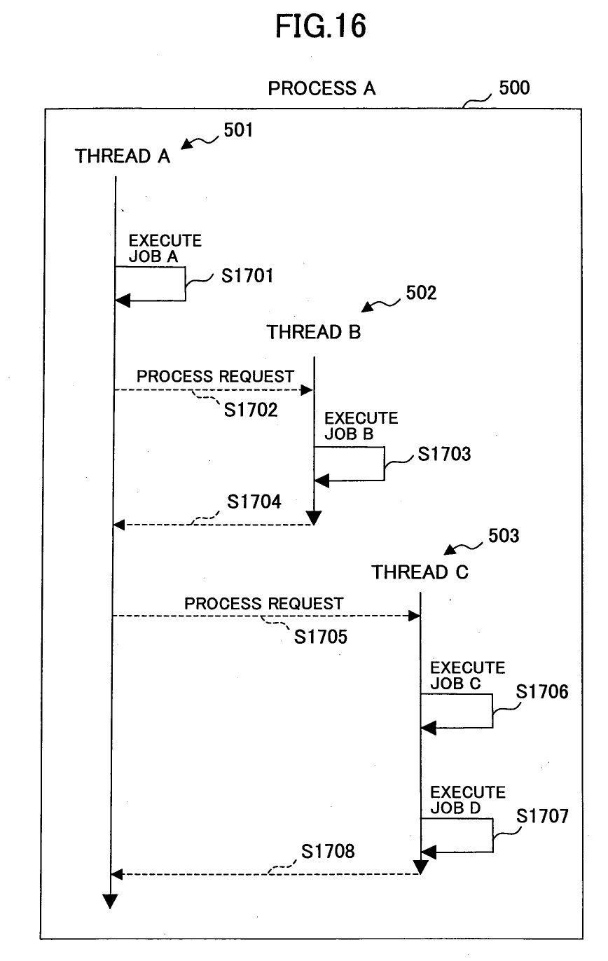

Next, referring to FIG. 16, a job process in the case of the single process and the multi-threads will be described. FIG. 16 shows a thread B 502 and a thread C 503 in addition to the process A 500, the thread A 501.

In this case, the thread A 501 as a main thread of the process A 500 executes the job A in step S1701. The thread A 500 requests a process with respect to the job B 451 as a sub-thread generated from the job A 500 in step S1702.

Subsequently, the thread B 502 executes the job B 451 in step S1703, and returns a response to the thread A 501 in step S1704. Moreover, the thread A 501 requests a process to the thread C 503 as another sub-thread generated from thread A 501 in step S1705. The thread C 503 executes the job C in step S1706, and executes the job D in step S1707. Then, the thread C 503 returns a response to the thread A 501 in step S1708.

As described above, in the case of the single process and the multi-threads, the thread A 501 has the thread B 502 as the sub-thread executed the job B 451, and has the thread C 503 as the sub-thread executed the job C 452. Moreover, the thread A 501 has the thread C 503 executed the job D 453, which is generated from the job C.

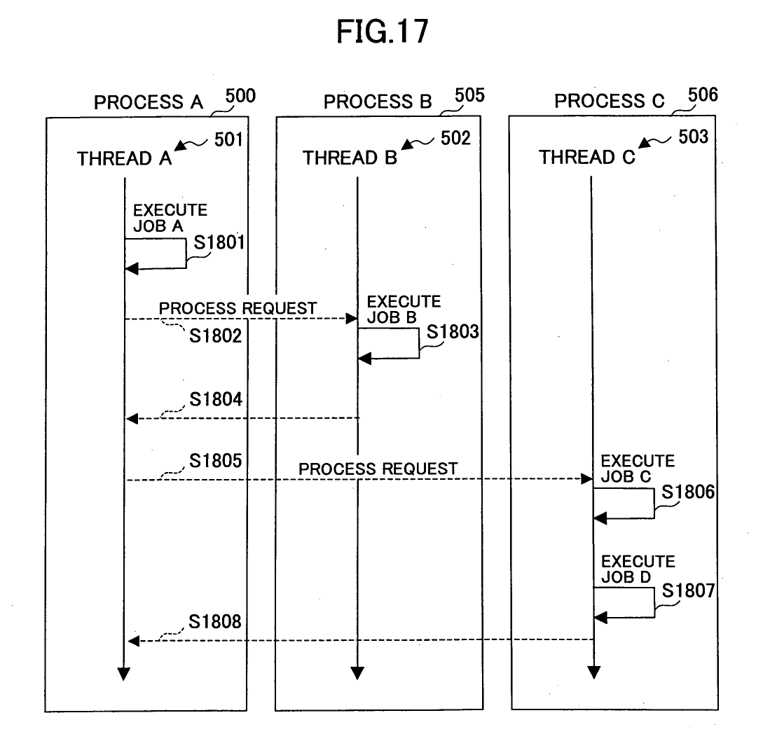

Next, referring FIG. 17, the case of the multi-processes and the single thread will be described. FIG. 17 shows a process B 505 and a process C 506 in addition to the process A 500, the thread A 501, the thread B 502, and the thread D 503. In this case, the thread A 501 is in the process A 500, the thread B 502 is in the process B 505, and the thread C 503 is in the process C 506.

The thread A 501 executes the job A 450 in step S1801, and the thread A 501 requests a process to the thread B 502 of the process B 505 in step S1802. The thread B 502 executes the job B 451 in step S1803, and the thread B 505 returns a response to the thread A 501 in step S1804.

The tread A 501 requests a process to the thread C 503 of the process C 506 in step S1805. The thread C 503 executes the job C 452 in step S1806, further executes the job D 453 in step S1807, and then returns a response to the thread A 450 in step S1808.

As described above, in the case of the multi-processes and the single thread, the thread A 501 as the main thread of the process A 500 executes the job A 450. Subsequently, the thread A 501 has the thread B 502 as a main thread of the process B 505 executed the job B generated from the job A 450, and has the thread C 503 as a main thread of the process C 506 executed the job C 453. Moreover, the thread A 501 has the thread C 503 executed the job D 453 generated from the job C 452.

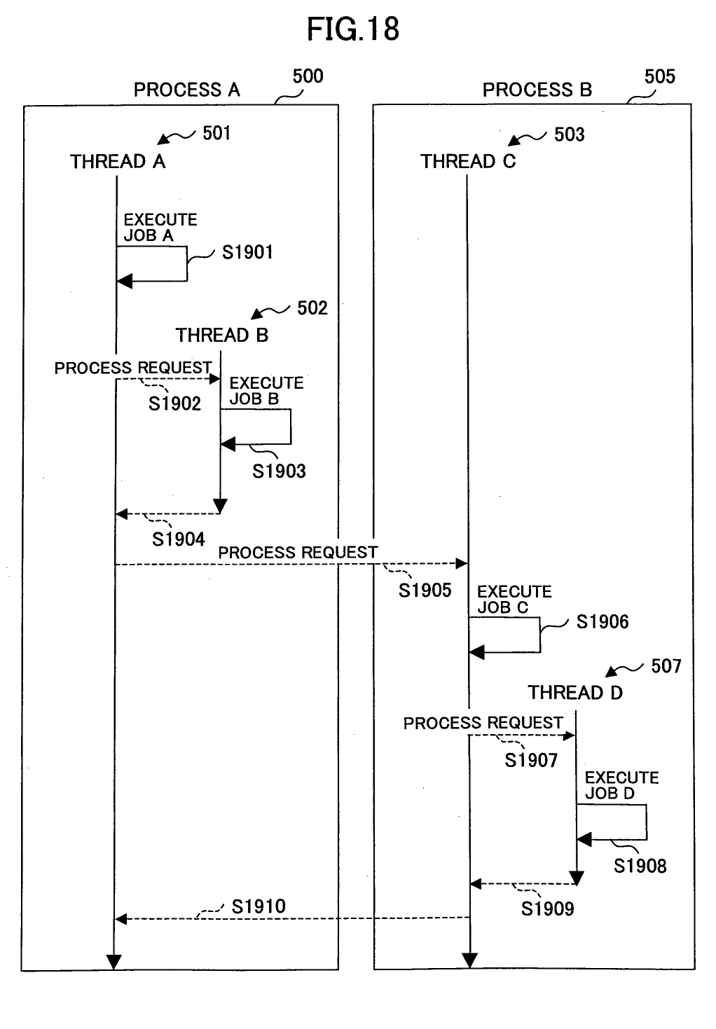

Next, referring to FIG. 18, the case of the multi-processes and the multi-threads will be described. FIG. 18 shows a thread D 507 in addition to the process A 500, the process B 505, the thread A 501, the thread B 502, and the thread C 503.

The process A 501 of the process A 500 executes the job A 450 in step S1901. The thread A 501 requests a process to the thread B 502 in the same process A 500 in step S1902. The thread B 502 executes the job B 451 in step S1903, and returns a response to the thread A 501 in step S1904.

The thread A 501 requests a process to the thread C 503 of the process B 505 in step S1905. The thread C 503 executes the job C 452 in step S1906. The thread C 503 requests a process to the thread D 507 in the same process B 505 in step S1907. The thread D 507 executes the job D 453 in step S1908, and returns a response to the thread C 503 in step S1909. The thread C 503 returns a response to the thread A 501 in step S1910.

As described above, in the case of the multi-processes and the multi-threads, the job A 450 is processes by the thread A 501 being a main thread of the process A 500. Moreover, the thread A 501 has the thread B 502 being a sub-thread of the process A 500 executed the job B 451 generated from the job A 450. Furthermore, the thread A 501 has the thread C 503 being a main thread of the process B 505 executed the job C 452 being generated from the job A 450, and has the thread D 507 being a sub-thread of the process B 505 executed the job D 453 generated from the job C 452.

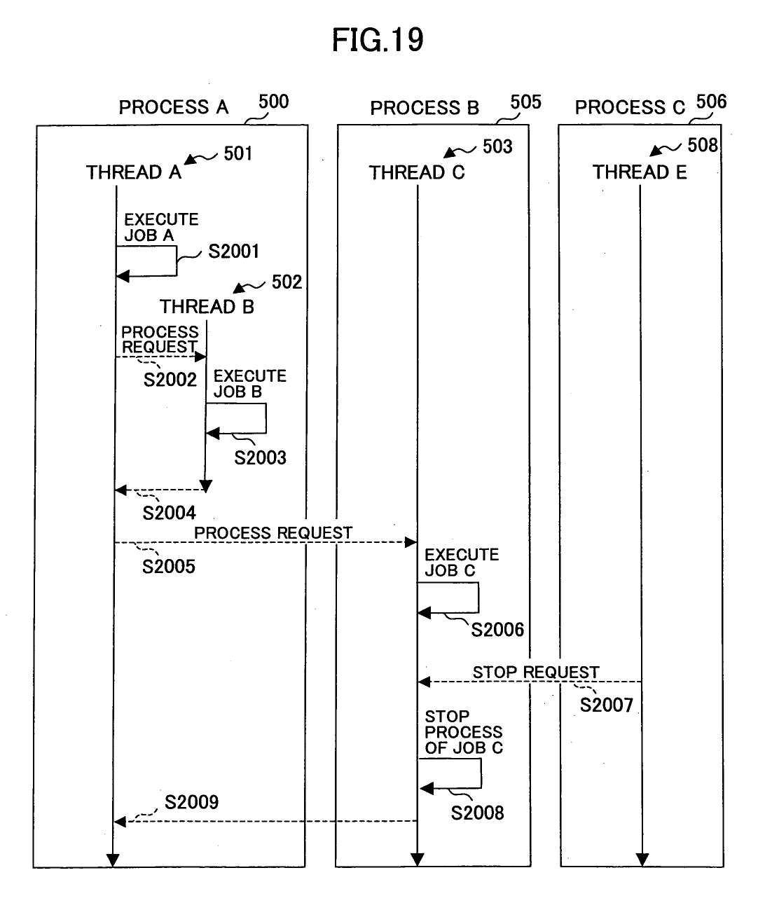

The implementing methods for the four cases are described above. In addition to theses implementing methods, an example of operating a process of a job in response to a request from the user in the implementing method using the multi-processes and the multi-threads will be described with reference to FIG. 19. FIG. 19 shows a thread E 508 in addition to the process A 500, the process B 505, the process C 506, the thread A 501, the thread B 502, and the thread C 503.

In these processes, the process C 506 is a process, which will be conducted in response to the request from the user. The thread A 501 of the process A 500 executes the job A 450 in step S2001. The thread A 501 requests a process to the thread B 502 in the same process A 500 in step S2002. The thread B 502 executes the job B 451 in step S2003, and returns a response to the thread A 501 in step S2004.

The thread A 501 requests a process to the thread C 503 of the process B 505 in step S2005. The thread C 503 executes the job C 452 in step S2006.

In this case, the thread E 508 of the process C 506 requests the thread C 503 to cancel a process in step S2007. The thread C 503 executes a cancel process with respect to the job C 452 in step S2008, and returns a response to the thread A 501 in step S2009.

As described above, in a case of an operation from the user, a process (process C 506) exists to accept an operation. The process accepts a cancel request from the user, and sends a cancel inquire to a respective job.

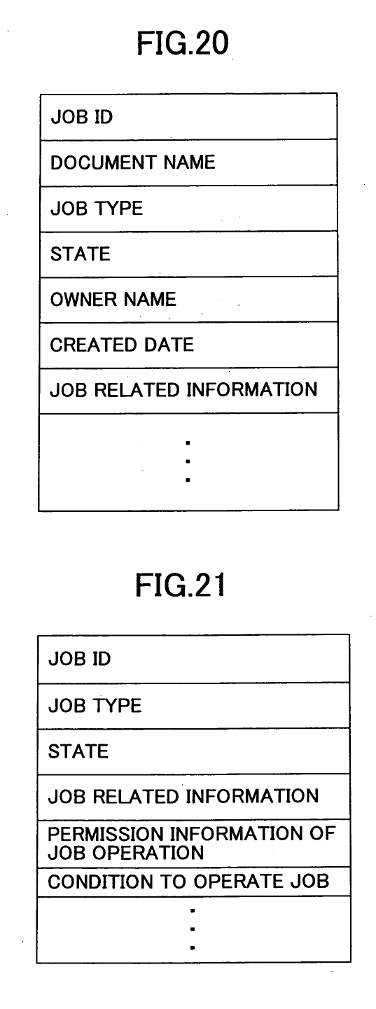

Next, the job information, which is information concerning each job, will be described with reference to FIG. 20. As shown in FIG. 20, the job information includes the job ID corresponding to identification information, a document name, a job type, a state, an owner name, a created date, and job related information.

In the job information, the job related information makes it possible to build the job structure of the job in the MFP, and will be described later. If it is possible to build the job structure, the parent-child relationship of jobs can be recognized.

In the job information, the job ID identifies each job by “1” or “2”, and is uniquely assigned to each job. In the following, a job, in which the job ID is “n” (n=1, 2, . . . ), is simply expressed as a job n.

The document name shows a name of a document to print out. For example, the document name is expressed with a character string. The job type shows which process such as “print”, “FAX transmission”, or a like is for a job. The state shows the job state such as “execution”, “error”, or a like. The owner name shows a user name such as “suzuki”, “sato”, or a like who requests an execution of a job. The created date shows a date and time such as “2004.02.17.12: 15” when a job is created.

Another example of the job information will be described with reference to FIG. 21. Different from the job information shown in FIG. 20, the job information shown in FIG. 21 includes two items of “permission information of job operation” and “condition to operate job”.

These two items are used to permit a job operation and a job state reference. Each job has the job state such as “execution”, “error occurrence”, or the like, and the user is permitted to conduct an operation of the re-execution or the cancel with respect to the job.

However, there are jobs which do not permit the user to operate or permit the user to operate only when a certain condition is satisfied. In a case of implementing the job in this manner, it is necessary for the job information to additionally include attributes such as the “permission information of job operation” and the “condition to operate job”.

In these attributes, the “permission information of job operation” will be described. The “permission information of job operation” can have a value showing a “permitted”, a “not permitted”, and a “permitted when condition occurs”.

The “permitted” shows that an operation (re-exetute/cacel/interrupt) corresponding to the job state can be conducted in any case. The “not permitted” shows that no operation with respect to the job can be conducted in any case. The “permitted when condition occurs” shows that an operation corresponding to a condition can be conducted when the “condition to operate job” shown in FIG. 21 is satisfied. Specifically, an operation for a re-execution or a cancel can be conducted when an error occurs.

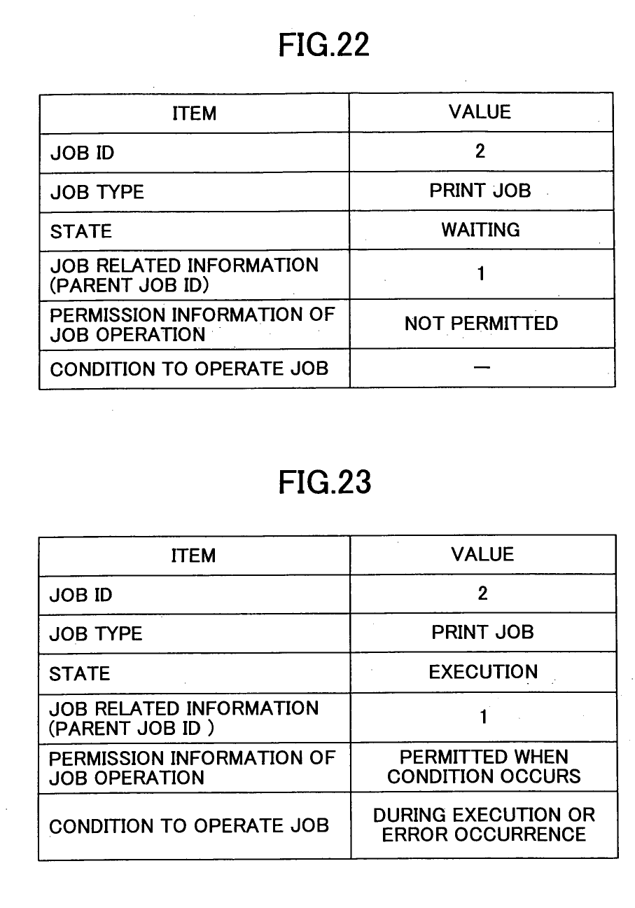

In these values, the job information in a case of the “not permitted” is shown in FIG. 22. The “permission information of job operation” in the job information shows the “not permitted”. Moreover, the job information in a case of the “permitted when condition occurs” is shown in FIG. 23. The “permission information of job operation” of the job information is the “permitted when condition occurs”, and the “condition to operate job” shows a “during execution or error occurrence”.

It should be noted that the “condition to operate job” may have other values showing an “error occurs”, an “execution or error occurrence”, a “waiting or error occurrence”, and an “execution or waiting or error occurrence”. The “error occurrence” is a condition in that an error occurs to a job. The “execution or error occurrence” is a condition in that a job is being executed or an error occurs to the job. The “waiting or error occurrence” is a condition in that a job is waiting or an error occurs to the job. The “execution or waiting or error occurrence” is a condition in that a job is being executed or the job is waiting or an error occurs to the job.

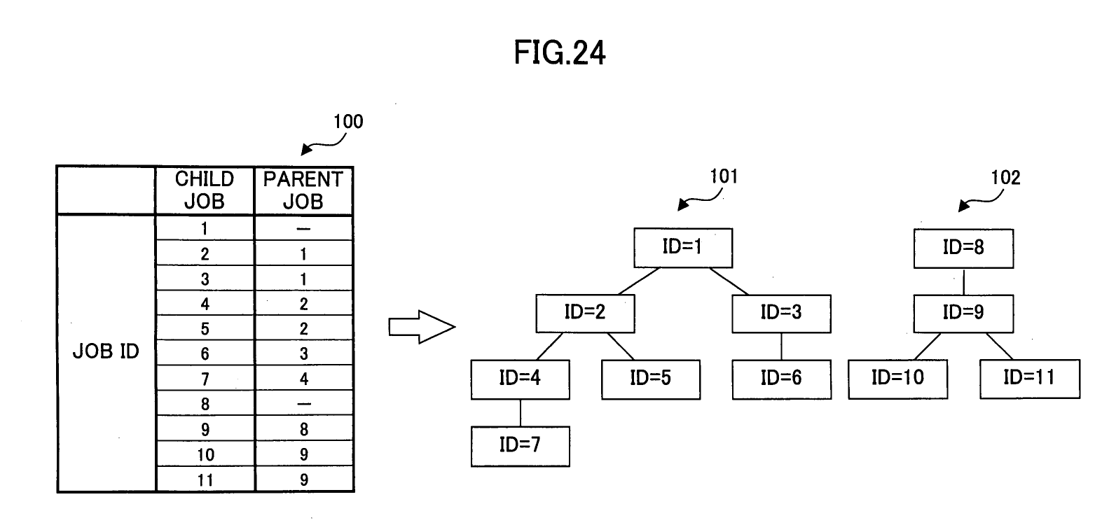

Next, a job structure table, which is created based on the job related information, will be described with reference to FIG. 24. The job structure table 100 includes IDs of a parent job and a child job. The “child job” shows the job ID (called a child job ID) and “parent job” shows a job ID (called a parent job ID) of a parent job of the child job having the child job ID. Accordingly, the job, which does not have the parent job ID, does not have the parent job, and the job is the root job.

Moreover, job structures 101 and 102 show the job structure table 100 as the job structure.

From the job structure table 100 in FIG. 24, it can be seen that a job 1 and a job 8 are the root jobs. Moreover, in the job structure table 100, since both parent jobs of a job 2 and a job 3 have the same parent job ID showing “1”, the jobs 2 and 3 are generated from the job 1. Similarly, for other jobs, the job structure shown in FIG. 24 can be generated by referring each job ID shown in the job structure table 100.

As described above, it is possible to create the job structure table 100 by maintaining the job ID of the parent job for each job. Moreover, it is possible to display the job structure at a screen of the personal computer or at an operation panel mounted to the MFP, by using the job structure table 100.

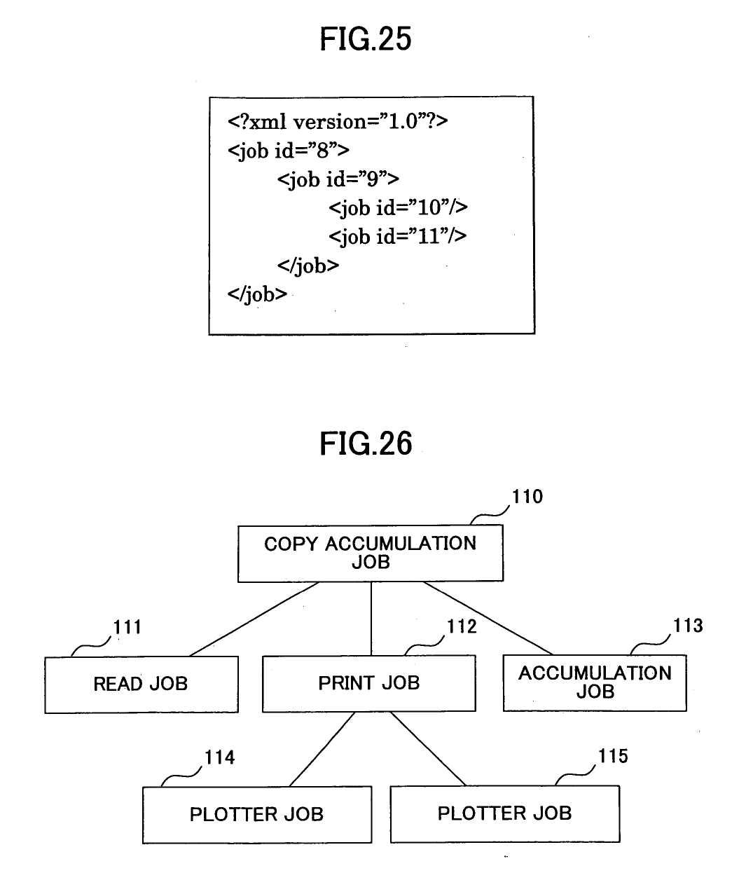

It should be noted that the job structure table 100 can be written in the XML (extensible Markup Language). An XML description shown in FIG. 25 shows a job structure 102 of jobs, which are generated from a job 8 as the root job.

Referring to FIG. 25, it can be seen that the job 8 has jobs 9, 10, and 11 as a child job and grandchildren jobs. Similarly, it can be seen that the job 9 has the job 8 as a parent job, and has the jobs 10 and 11 as children jobs. Moreover, it can be seen that both the jobs 10 and 11 have the same job 9 as the parent job.

As described above, it is possible to express the job structure table 100 by using the XML description nesting job IDs. Also, it can be seen that the job structure table 100 shows a relationship between an arbitrary job and another job.

The outline of the process is described. Next, each process is described in detail. First, referring to FIG. 26, a job generated in the MFP will be described in an example of copy. FIG. 26 shows a copy accumulation job 110, a read job 111, a print job 112, an accumulation job 113, and plotter jobs 114 and 115. The root job in this job structure is the copy accumulation job 110.

In response to a request of a copy accumulation, the copy accumulation job 110 occurs, and in order to realize the request, the read job 111, the print job 112, and the accumulation job 113 are generated. From print job 112, the plotter jobs 114 and 115 are further generated.

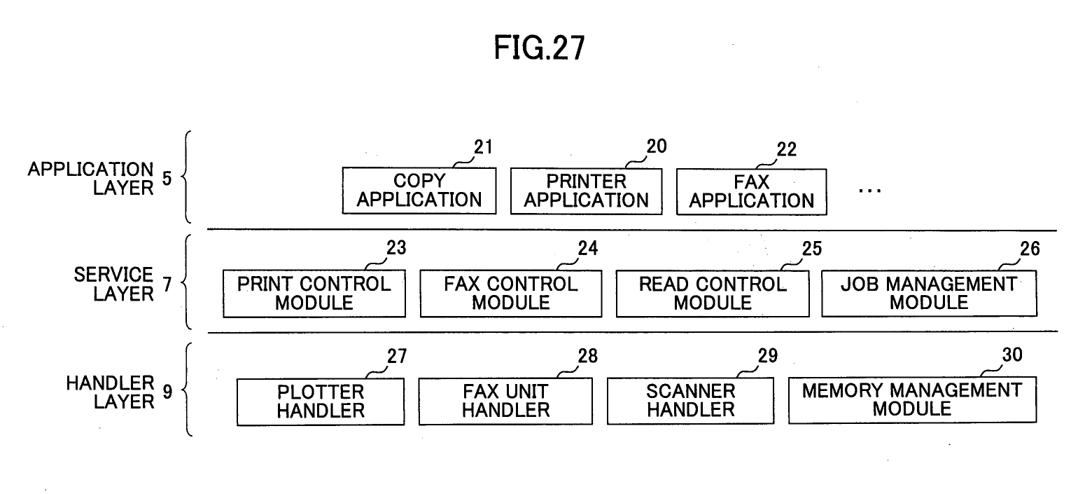

Next, referring to FIG. 27, software blocks of the MFP will be described. An “application”, a “module”, and a “handler” described in FIG. 27 are collectively called programs.

The software blocks shown in FIG. 27 are categorized into three layers: an application layer 5, a service layer 7, and a handler layer 9. The application layer includes programs such as a copy application 21, a printer application 20, a FAX application 22, and a like. The service layer 7 includes programs such as a print control module 23, a FAX control module 24, a read control module 25, and a job management module 26. The handler layer 9 includes programs such as a plotter handler 27, a FAX unit handler 28, a scanner handler 29, and a memory management module 30.

The copy application 21, the printer application 20, and the FAX application 22 in the application layer 5 are applications for a copiers, a printer, and a facsimile, respectively.

Next, modules in the service layer 7 will be described. The print control module 23 is a module for controlling a print process. The FAX control module 24 is a module for controlling a FAX process. The read control module 25 is a module for controlling a read process. The job management module 26, which corresponds to an entire job structure information creating part and a job searching part, is a module for creating the job structure table (job structure information) by a request, and for sending the job structure table (job structure information) to a request originator.

Next, programs in the handler layer 9 will be described. The programs in the handler layer 9 are handlers for a plotter, a scanner, and a like, which are hardware.

The plotter handler 27 is a handler for the plotter. The FAX handler 28 is a handler for the FAX unit. The scanner handler 29 is a handler for the scanner. The memory management module 30 is a handler for management a memory or a hard disk.

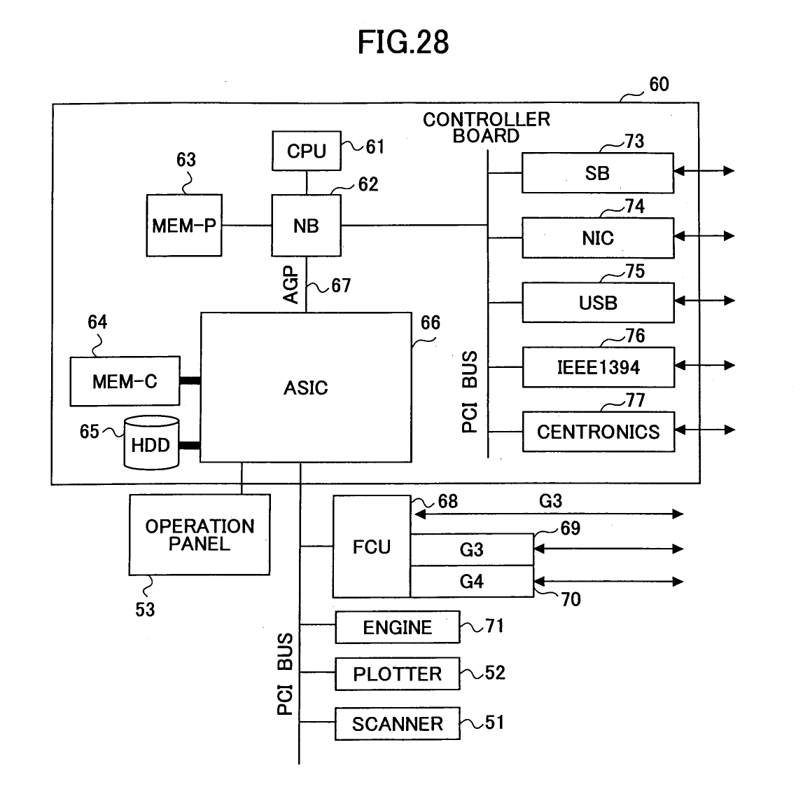

Next, a hardware configuration of the MFP will be described with reference to FIG. 28. The MFP includes a controller board 60, an operation panel 53, an FCU (Fax Controller Unit) 68, an engine 71, a scanner 51, and a plotter 52. Moreover, the FCU 68 includes a G3 standard unit 69 and a G4 standard unit 70.

Moreover, the controller board 60 includes a CPU (Central Processing Unit) 61, an ASIC (Application Specific Integrated Circuit) 66, an HDD (Hard Disk Drive) 65, a local memory (MEM-C) 64, and a system memory (MEM-P) 63, and a north bridge (hereinafter, called NB) 62, a south bridge (hereinafter, called SB) 73, an NIC (Network Interface Card) 74, a USB (Universal Serial Bus) 75, an IEEE 1394 device 76, and a centronics device 77.

The operation panel 53 is connected to the ASIC 66 of the controller board 60. Moreover, the SB 73, the NIC 74, the USB device 75, the IEEE 1394 device 76, and the centronics device 77 are connected to the NB 62 through a PCI bus.

Moreover, the FCU 68, the engine 71, the scanner 51, and the plotter 52 are connected to the ASIC 66 of the controller board 60 through another PCI bus.

In the controller board 60, the ASIC 66 is connected to the local memory 64 and the HDD 65, and is also connected to the CPU 61 through the NB 62 of a CPU chipset. As described above, by connecting the CPU 61 to the ASIC 66 through the NB 62, it is possible to communicate with the CPU 61 even if an interface of the CPU 61 is not opened to the public.

The ASIC 66 is not connected to the NB 62 through the PCI bus but the ASIC 66 is connected to the NB 62 through an AGP (Accelerated Graphics Port) 67. As described above, in order to execute and control more than one process forming the application layer 5, the ASIC 66 is connected to the NB 62 through the AGP 67, instead of the PCI bus having a lower speed, so as to prevent performance to be degraded.

The CPU 61 controls the entire MFP. The CPU 61 activates and executes programs included in the application layer 5, the service layer 7, and the handler layer 9 on an OS (Operating System) as processes, respectively.

The NB 62 is a bridge to connect the CPU 61, the system memory 63, the SB 73, and the ASIC 66 with each other. The system memory 63 is used as a memory for drawing an image in the MFP. The SB 73 is a bridge to connect the NB 62 with the PCI bus and peripheral devices. Moreover, the local memory 64 is a memory used as an image buffer for a copy, and a coding buffer.

The ASIC 66 is an IC (Integrated Circuit) for an image process and having hardware factors for the image process. The HDD 65 is storage for accumulating image data, document data, programs, font data, forms, and a like. Moreover, the operation panel 53 is an operating part for accepting an input operation from the user and for conducting a display for the user.

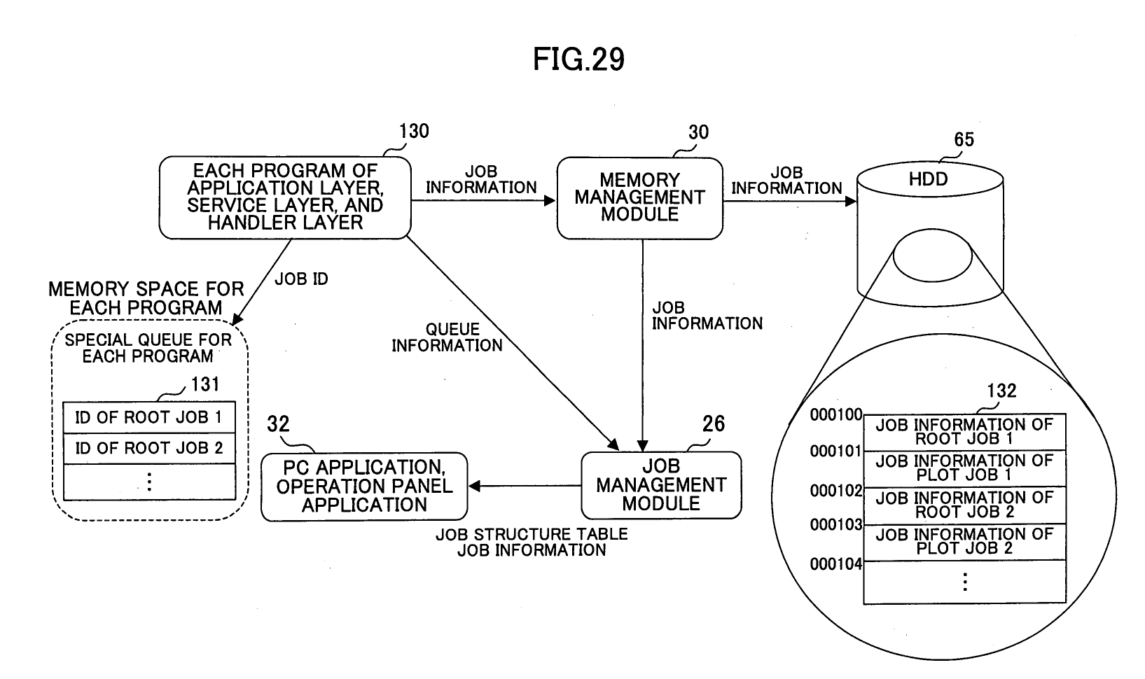

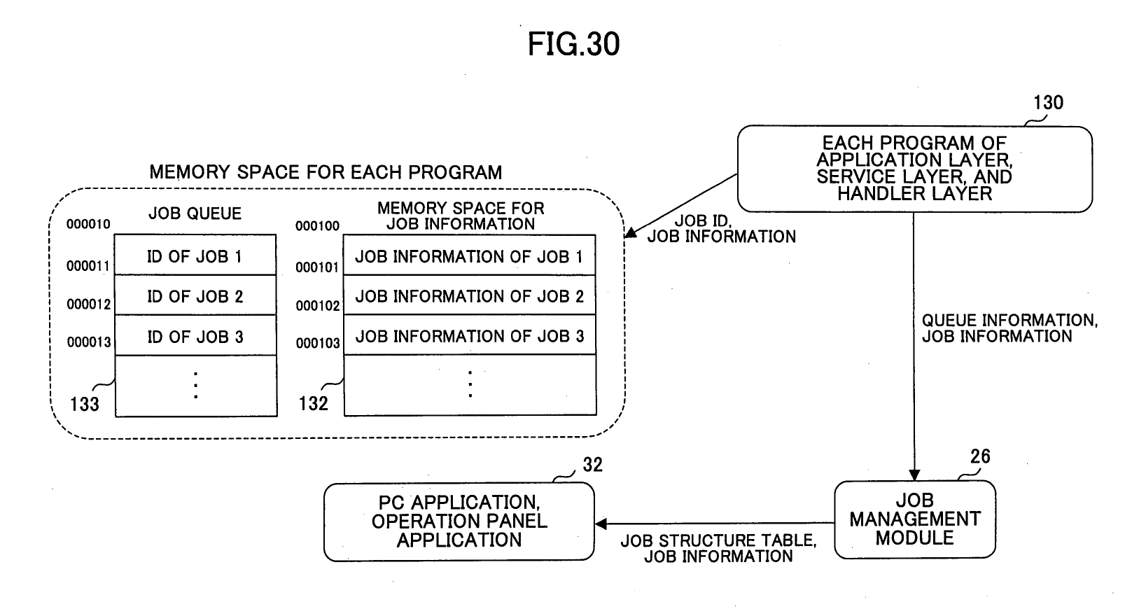

Next, each relationship among software described above and information exchanged among software will be described with reference to FIG. 29 and FIG. 30. FIG. 29 is a diagram showing a case in that the job information is recorded in the HDD 65. FIG. 30 is diagram showing a case in that the job information is recorded to the memory.

First, the case shown in FIG. 29 will be described. In FIG. 29, each program 130, the memory management module 30, the HDD 65, the job information 132, the job management module 26, the display application 32, and a special queue 131 are shown.

Each program 130 is each of programs of the application layer 5, the service layer 7, and the handler layer 9. In detail, the program 130 is one of programs of the job management module 26 and other than the memory management module 30, to occur and process a job. The display application 32 is a PC application for a display at a personal computer, or an application for the operation panel 53 described above. The job information 132 is the job information described in FIG. 20. In the case shown in FIG. 29, the special queue 131 being recorded in the HDD 65 is a queue special to manage jobs by each program being stored in a memory space for the program.

The memory space for each program is a memory area assigned for the program. Each module has a respective special queue in the memory space, manages an order of jobs to process.

The job information is provided from each program 130 to the memory management module 30. The memory management module 30 records the job information to the HDD 65. Moreover, the memory management module 30 provides the job information to the job management module 26. The job management module 26 provides the job structure table and the job information to the display application 32. Each program 130 provides information concerning the queue to the job management module 26. Also, each program 130 records the job ID to the special queue 131.

Next, the case in FIG. 30 will be described. In FIG. 30, parts that are the same as the ones in FIG. 29 are indicated by the same reference numerals and the explanation thereof will be omitted. Different from FIG. 29, a queue 133 and job information 132 are shown in FIG. 30. As shown in FIG. 30, the queue 133 and the job information 132 are recorded in the memory space for each program 130. Accordingly, the queue-133 and the job information 132 are special for each program.

Each program 130 records the job ID and the job information to the queue 133 and the job information 132. Also, the each program 130 provides information concerning the queue 133 and the job information to the job management module 26. The job management module 26 provides the job structure table and the job information to the display application 32. The display application 32 corresponds to a graphic user interface displaying part and a job structure information obtaining part.

In the case in FIG. 30, the job information is not maintained in the HDD 65 but is maintained in the memory space managed by each program. Accordingly, the job management module 62 obtains the job information from each program 130 having a job, and creates the job structure table.

Next, the job related information will be described. As described above, the job related information is needed to create the job structure table. Various types of information can be considered as the job related information. In the following, seven types of the job related information and sequence flows for respective processes will be described. Processes, which will be described in accordance with the sequence flows, are a job registration process when a print request is conducted, and a process when a job is referred to.

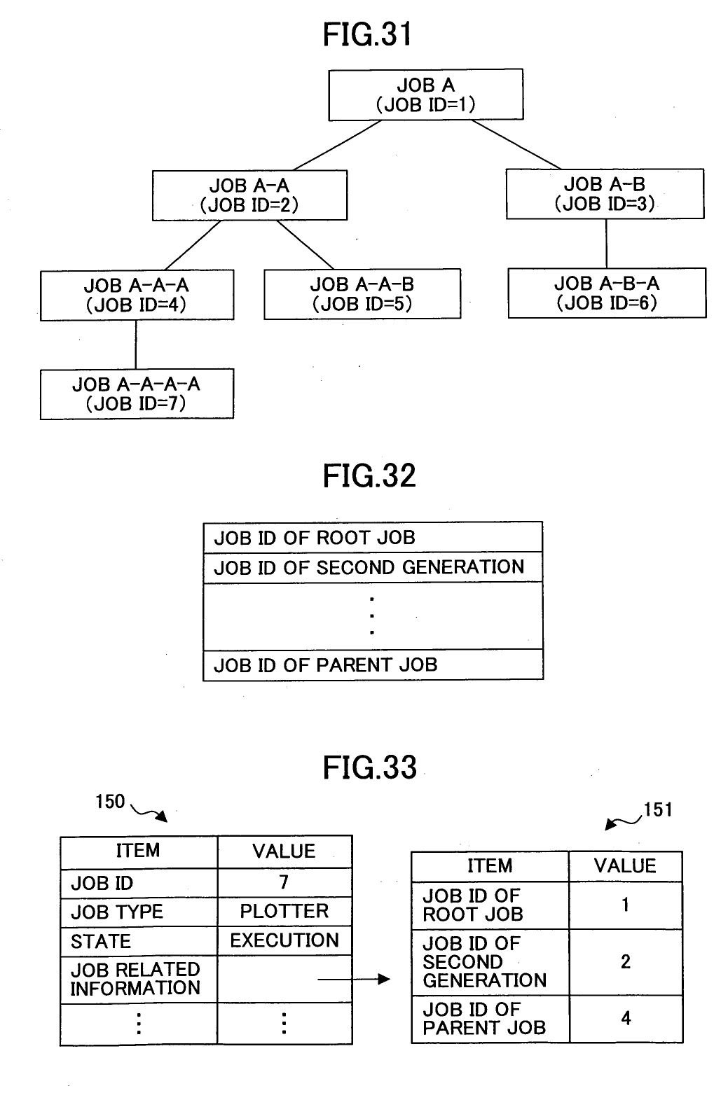

Each of the job information is based on the structures shown in FIG. 20 and FIG. 21. The following job structure is a job structure shown in FIG. 31. The job structure shown in FIG. 31 shows a job structure of jobs generated from the job A 450.

A first example of the job related information will be described with reference to FIG. 32. Regarding the job related information shown in FIG. 32, a child job has job IDs of all ancestral jobs from the job IDs of the parent jobs of the child job to the job ID of the root job.

In detail, the job information will be described with reference to FIG. 33. The job information shown in FIG. 33 is job information for the job 7 in FIG. 31.

In FIG. 33, job information 150 and job related information 151 are shown. The job information 150 is the same job information described in FIG. 20. The job related information 151 includes items of “job ID of root job”, “job id of second generation”, and “job ID of parent job”, which show values “1”, “2”, and “4”, respectively.

The parent job of the job 7 is a job 4, the second generation of the job 7 is a job 2, and the root job is the job 1.

As described above, the child job has job IDx of all ancestral jobs, and the job management module 62 identifies the end job. Therefore, the job management module 62 can create the job structure table by simply obtaining information concerning the end job. Also, each program of the application layer 5, the service layer 7, and the handler layer 9 simply adds the job ID of the parent job to the job structure table of the parent job when a job is created, and can create the job related information. As a mechanism for the job management module to identify the end job, a flag for determining whether or not a job is the end job is provided to the job information.

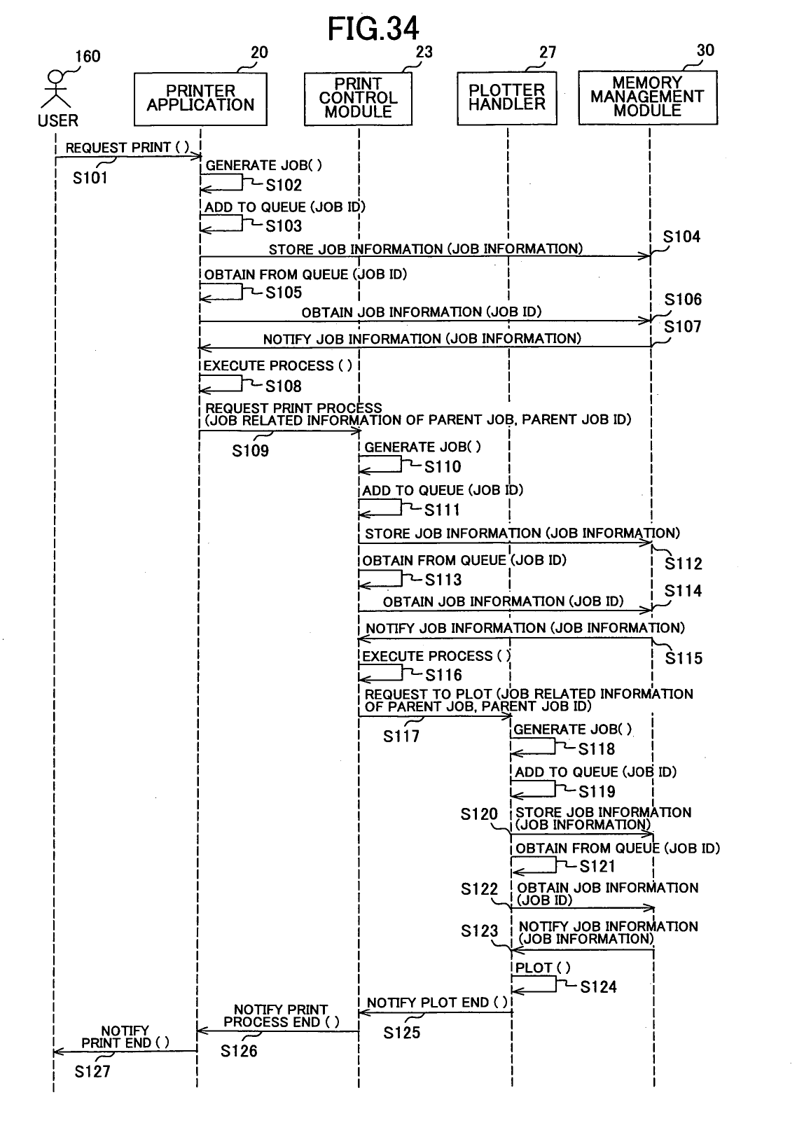

A process in the case of the first example of the job related information will be described in accordance with a sequence flow. FIG. 34 shows an operation sequence flow when a job is registered, and shows processes conducted among a user 160, the printer application 20, the print control module 23, the plotter handler 27, and the memory management module 30. The processes in FIG. 30 are similarly conducted in the following operation sequence flow when the job is registered.

The printer application 20 receives a request to print out from the user 160 in step S101. The printer application 20 generates a job in step S102, and adds a job ID of the job to a queue in step S103. The printer application 20 sends job information to the memory management module 30 to store the job information in step S104.

In step S105, the printer application 20 obtains the job ID form the queue. The printer application 20 requests the plotter handler 27 to obtain the job information in step S106. The memory management module 30 sends the job information to the printer application 20 in step S107. The printer application 20 executes a process in step S108.

The printer application 20 sends a request of a print process to the print control module 23 in step S109. In this step, the job related information of the parent job and the job ID of the parent job are also sent with this request. The print module 23 generates a job in step S110, adds a job ID of the job to a queue in step S111. Then, the print control module 23 stores the job information in step S112. The print control module 23 obtains the job ID from the queue in step S113.

The print control modules 23 requests the memory management module 30 to obtain the job information in step S114. The memory management module 30 sends the job information to the print control module 23 in step S115.

A process of the print control module 23 is executed in step S116. The print control module 23 sends the plotter handler 27 a request to plot in step S117. In this step, the job related information of the parent job and the job ID of the parent job are also sent to the plotter handler 27.

In step S118, the plotter handler 27 generates a job. The plotter handler 27 adds a job ID of the job to a queue in step S119, and stores the job information in step S120. The plotter handler 27 obtains the job ID from the queue in step S121. The plotter handler 27 requests the memory management module 30 to obtain the job information in step S122. The memory management module 30 sends the job information to the plotter handler 27 in step S123.

The plotter handler 27 executes a plot process in step S124. The plotter handler 27 notifies a plot end to the print control module 23 in step S125. The print control module 23 notifies a print process end to the printer application 20 in step S126. The printer application 20 notifies (displays) a print end to the user 160 in step S127.

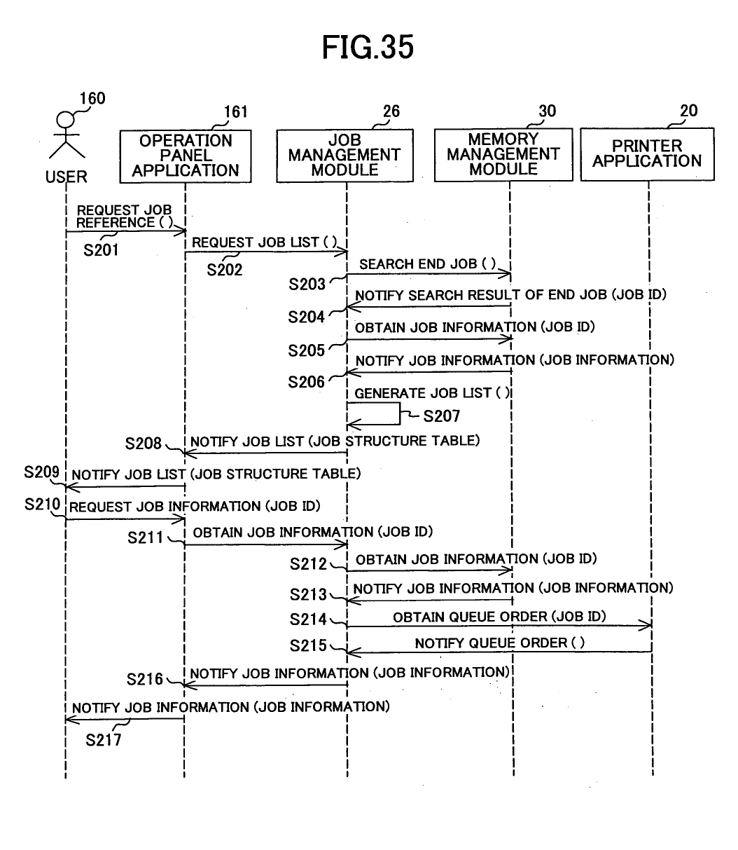

Next, referring to FIG. 35, an operation sequence flow when a job is referred to will be described. FIG. 35 shows processes conducted among the user 160, an operation panel application 161, the job management module 26, the memory management module 30, and the printer application 20. The processes in FIG. 35 are similarly conducted in the following operation sequence flow when the job is referred to.

In step S201, the operation panel application 161 receives a request of a job reference from the user 160. The operation panel application 161 sends a request of a job list to the job management module 26 in step S202. The job management module 26 instructs a search of end jobs to the memory management module 30 in step S203. The memory management module 30 notifies a search result of the end jobs to the job management module 26 in step S204. The job management module 26 requests the memory management module 30 to obtain the job information in step S205. The memory management module 30 notifies the job information to the job management module 26 in step S206. The job management module 26 creates the job list in step S207.

In step S208 corresponding to step of receiving a job structure, the job management module 26 notifies the job list to the operation panel application 161. The operation panel application 161 notifies (displays) the job list to the user 160 in step S209 corresponding to a step of conducting a graphical user interface display. The operation panel application 161 receives a request of the job information from the user 160 in step S210. The operation panel application 161 requests the job management module 26 to obtain the job information in step S211. The job management module 26 requests the memory management module 30 to obtain the job information in step S212. The memory management module 30 notifies the job information to the job management module 26 in step S213.

The job management module 26 requests the printer application 20 to obtain an order of a queue in step S214. The printer application 20 notifies the order of the queue to the job management module 26 in step S215. The job management module 26 notifies the job information to the operation panel application 161 in step S216. The operation panel application 161 notifies (displays) the job information to the user 160 in step S217.

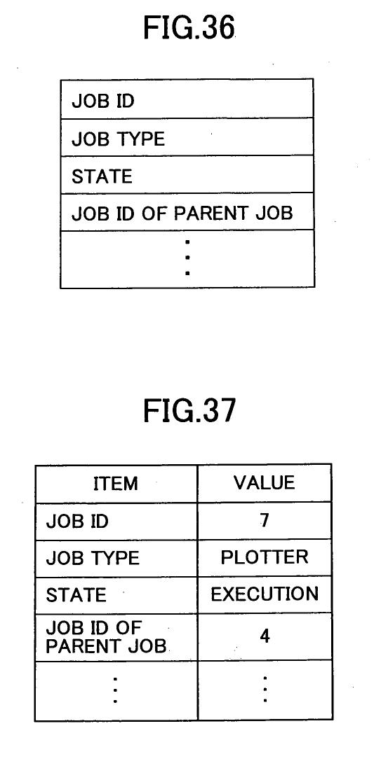

Next, a second example of the job related information will be described with reference to FIG. 36. As shown in FIG. 36, the second example of the job related information shows only job ID of the parent job in the job information.

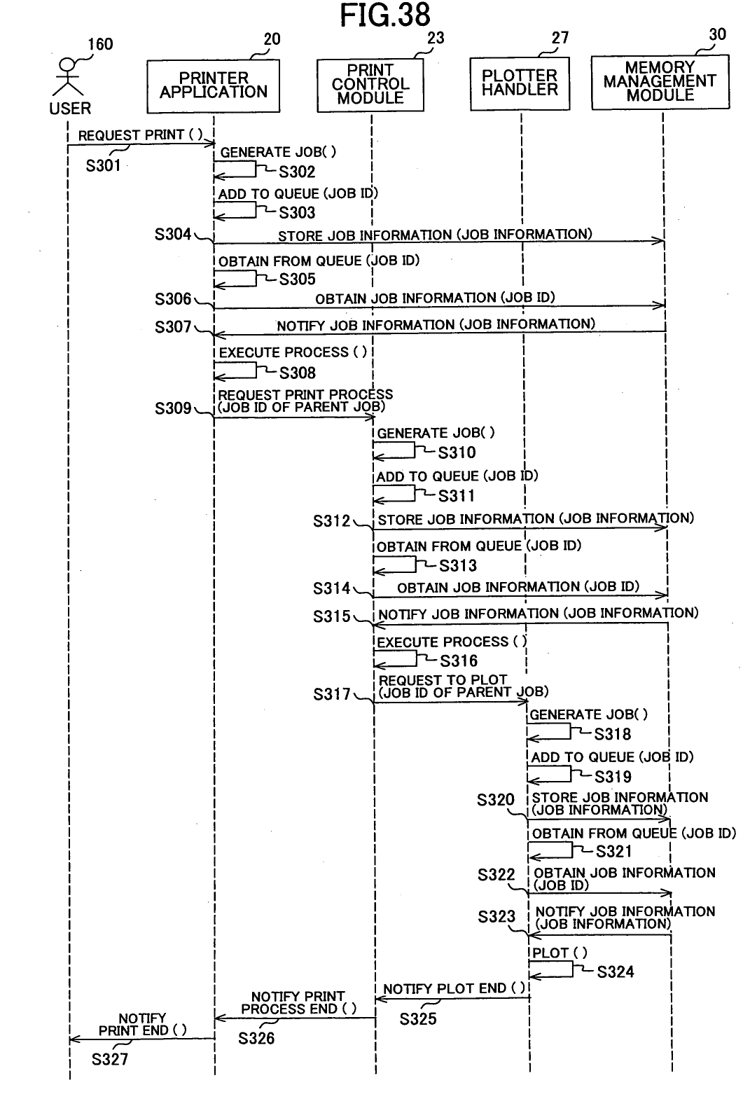

In detail, the job information will be described with reference to FIG. 37. The job information shown in FIG. 37 is job information of the job 7 in FIG. 31. The job related information shows only “job ID of parent job”, and “job ID of parent job” has a value showing “4”, but the job related information does not show any item concerning other job IDs.

In a case in that the job related information shows only the job ID of the parent job, it is possible to suppress an information amount of the job information. In this case, the job management module 26 is needed to access all jobs.

In the second example of the job related information as described above, an operation when a job is registered will be described with reference to a sequence flow shown in FIG. 38. In FIG. 38, steps other than two steps are the same as the ones shown in the sequence flow in FIG. 34, and the explanation thereof will be omitted.

Steps S301 through S308 in FIG. 38 correspond to steps S101 through S108 in FIG. 34, steps S309 through S316 in FIG. 38 correspond to steps S109 through S116 in FIG. 34, and steps S318 through S327 in FIG. 38 correspond to step S118 through S127 in FIG. 34.

Steps S309 and S317 in FIG. 38 are different from step S109 and S117 in FIG. 34.

In step S109 in FIG. 34, the job related information of the parent job is sent to the print control module 23. However, in step S309 in FIG. 38, only the job ID of the parent job is sent to the print control module 23. Moreover, in step S117 in FIG. 34, both the job related information of the parent job and the job ID of the parent job are sent to the plotter handler 27. However, in step S317 in FIG. 38, only the job ID of the parent job is sent to the plotter handler 27.

These differences are made since the job related information shows only the job ID of the parent job.

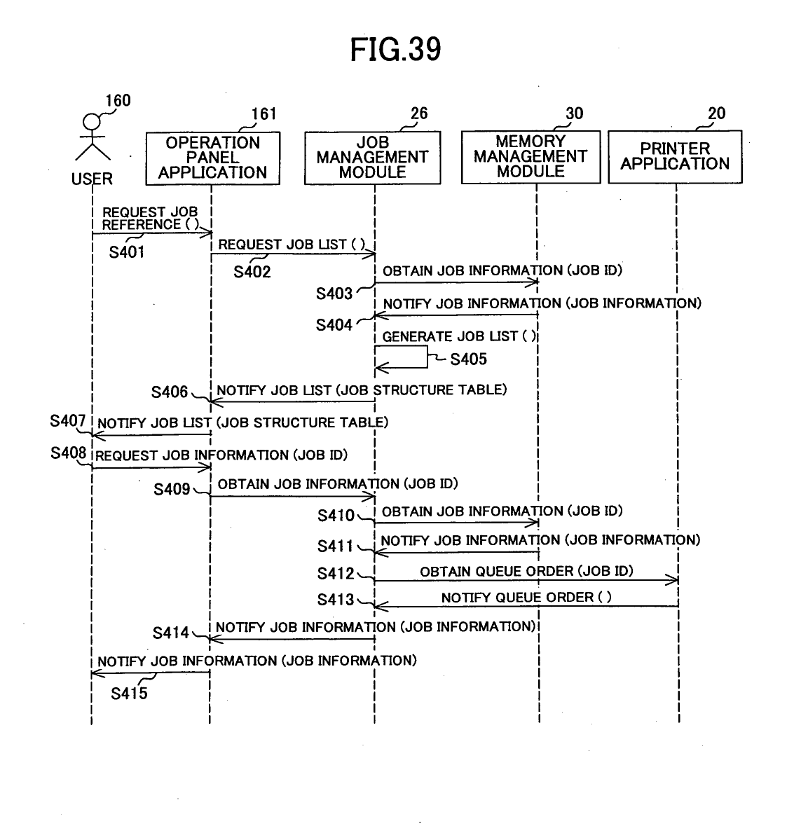

Next, an operation sequence flow when a job is referred to is described with reference to FIG. 39. In the sequence flow shown in FIG. 39, steps S401 and S402 correspond to steps S201 and S202 in FIG. 35, and steps S404 through step S415 correspond to steps S205 through S217 correspond to steps S403 through S415.

Accordingly, in the processes shown in FIG. 39, steps S203 and S204 to conduct a search process of the end jobs are omitted from the entire processes shown in FIG. 35. Since the job management module 26 accesses all jobs, it is not necessary to search for specific jobs.

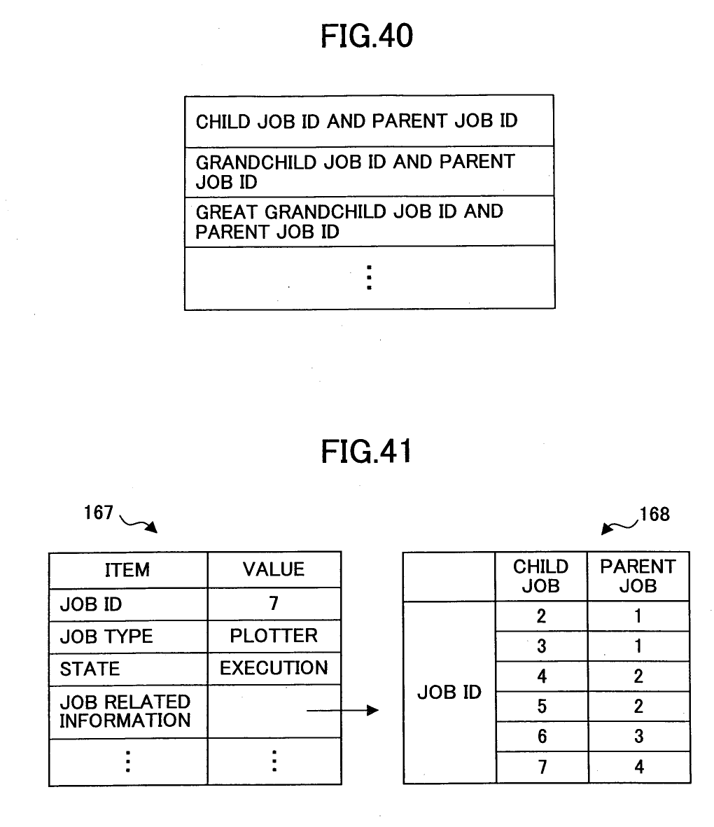

Next, a third example of the job related information will be described with reference to FIG. 40. In the job related information shown in FIG. 40, a job has job IDs of all descendant jobs.

In detail, job information shown in FIG. 41 will be described. In FIG. 41, job information 167 and job related information 168 are shown. The job information 167 is the job information of the job 7 in FIG. 31.

The job related information 168 includes items of “child job” and “parent job”. A job ID of the parent job of a job ID shown in “child job” is shown in “parent job”.

The parent jobs of the jobs 2 and 3 are the same job 1, the parent jobs of the jobs 4 and 5 are the same job 2, the parent job of the job 6 is the job 3, and the parent job of the job 7 is the job 4.

As described above, when the job related information shows the job IDs of the descendant jobs, the job management module 26 can create the job structure table by simply obtaining the job information of the root job. In this case, a module, which generates a job, is needed to inform the job ID of the job to all modules which generate ancestral jobs. Furthermore, it is necessary to search for the root job from jobs maintained by the job management module 26.

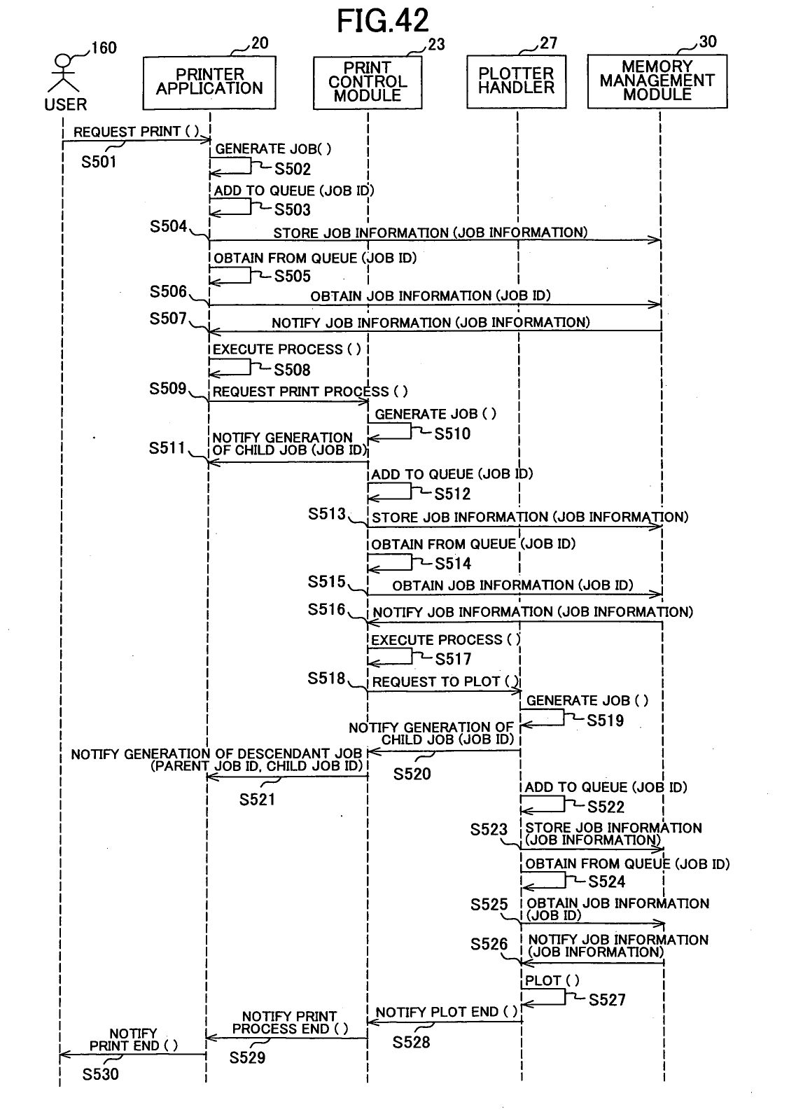

An operation when a job is registered in a case of the third example of the job related information will be described with reference to FIG. 42. In a sequence flow shown in FIG. 42, steps S501 through S508 are the same as steps S101 through S108 in the sequence flow shown in FIG. 34, and the explanation thereof will be omitted.

In step S509, the printer application 20 sends a request of a print process to the print control module 23. In this step, the job related information of the parent job and the job ID of the parent job are not sent to the print control module 23. The print control module 23 generates a job in step S510, and notifies generation of a child job to the printer application 20 in step S511. The printer application 20 adds a job ID to a queue in step S512. Then, the print control module 23 stores the job information in step S513. The print control module 23 obtains the job ID form the queue in step S514.

The print control module 23 requests the memory management module 30 to obtain the job information in step S515. The memory management module 30 notifies the job information to the print control module 23 in step S516.

A process of the print control module 23 is executed in step S517. The print control module 23 requests the plotter handler 27 to plot in step S518. The plotter handler 27 generates a job in step S519.

The plotter handler 27 notifies the job ID and generation of a child job to the print control module 23 in step S520. The print control module 23 notifies generation of a descendant job to the printer application 20 in step S521. In this step, both the job ID of the parent job and the job ID of the child job are also sent to the printer application 20.

The plotter handler 27 adds the job ID to a queue in step S522, and stores the job information in step S523. The plotter handler 27 obtains the job ID from the queue in step S524. The plotter handler 27 requests the memory management module 30 to obtain the job information in step S525. The memory management module 30 notifies the job information to the plotter handler 27 in step S526.

The plotter handler 27 executes a plot process in step S527. The plotter handler 27 notifies a plot end to the print control module 23 in step S528. The print control module 23 notifies a print process end to the printer application 20 in step S529. The printer application 20 notifies (displays) a print end to the user 160 in step S530.

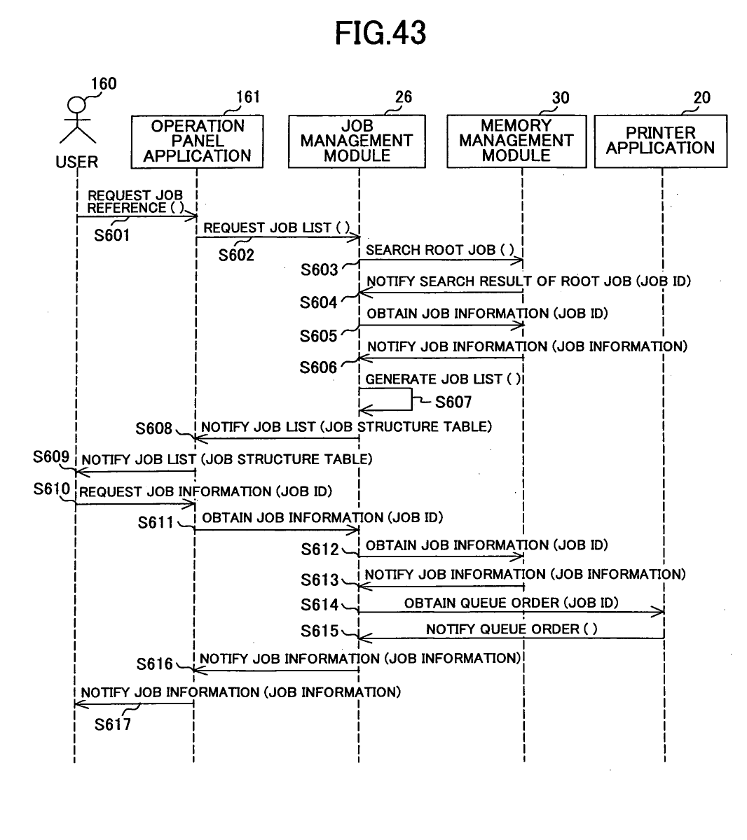

Next, a sequence flow when a job is referred to will be described with reference to FIG. 43. In the sequence flow shown in FIG. 43, steps other than two steps are the same as steps shown in FIG. 35, and the explanation thereof will be omitted.

Steps S601 and S602 in FIG. 43 correspond to steps S201 and S202 in FIG. 35, respectively. Also, steps S605, S606, S607, S608, S609, S610, S611, S612, S613, S614, S615, S616, and S617 in FIG. 43 correspond to steps S205, S206, S207, S208, S209, S210, S211, S212, S213, S214, S215, S216, and S217 in FIG. 35, respectively.

Steps S603 and S604 in FIG. 43 are different from step S203 and S204 in FIG. 35. In FIG. 35, the end job is a subject to search for. In FIG. 43, the root job is a subject to search for.

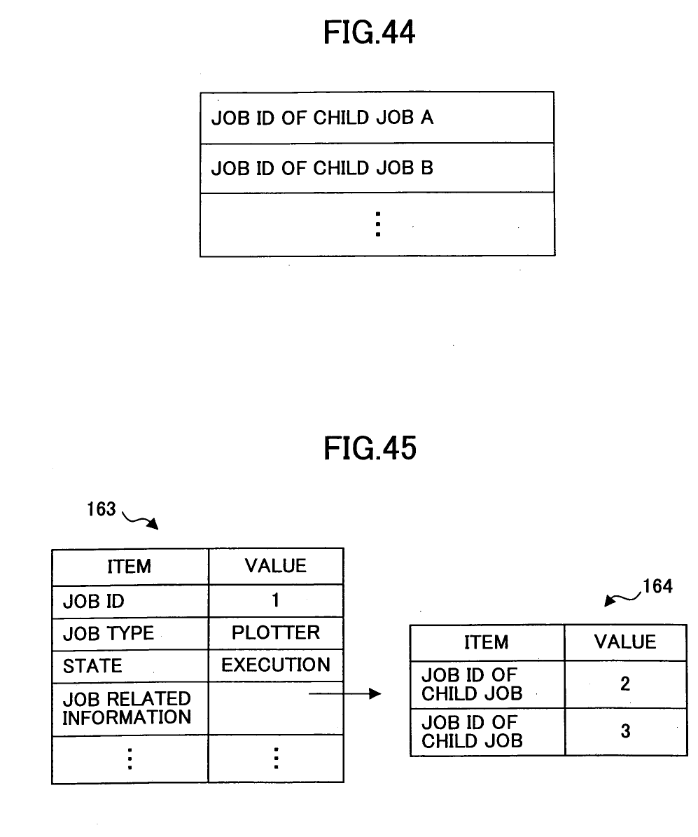

Next, a fourth example of the job related information will be described with reference to FIG. 44. In the job related information shown in FIG. 44, a job has job IDs of all child job.

In detail, job information shown in FIG. 45 will be described. In FIG. 45, job information 163 and job related information 164 are shown. The job information 163 is the job information of the job 1 shown in FIG. 31.

The job related information 164 shows “job ID of child job” having a value “2” and “job ID of child job” having a value “3”. The jobs 2 and 3 are children jobs of the job 1.

As described above, in a case in that the job related information shows job IDs of only children jobs, it is possible to suppress information amount of the job information. In this case, the job management module 26 is needed to access all jobs.

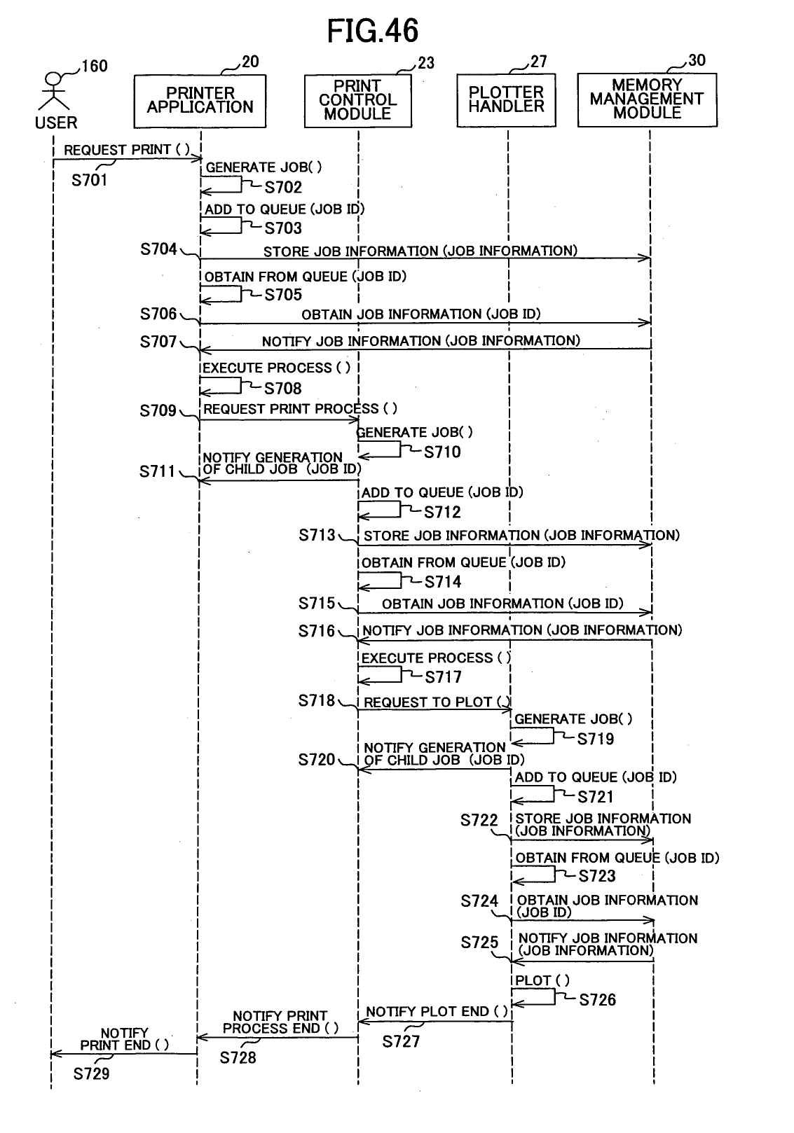

Processes in the case of the fourth example of the job related information will be described in accordance with a sequence flow shown in FIG. 46. In this sequence flow, all steps are the same as the ones in FIG. 42, however, the process in step S521 in the sequence flow shown in FIG. 42 is not conducted in the sequence flow in FIG. 46. In the fourth example of the job related information, since a descendent job is not needed, the process for notifying the generation of the descendent job in step S521 is not necessary.

An operation sequence flow when a job is referred to is the same as the operation sequence flow in FIG. 39, and the explanation thereof will be omitted.

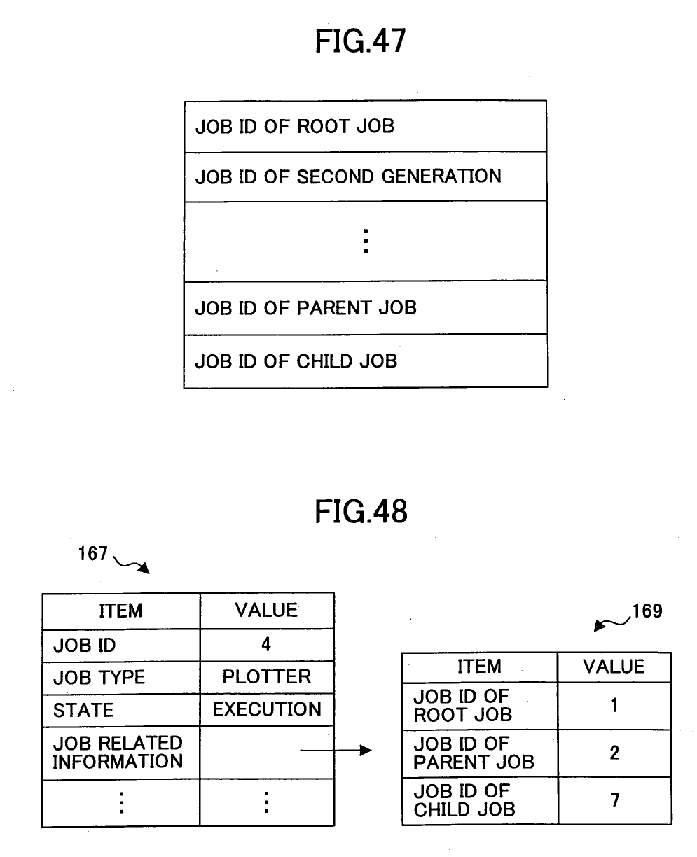

Next, a fifth example of the job related information combining the first example and the fourth example of the job related information will be described with reference to FIG. 47. The job related information shown in FIG. 47 includes job IDs of all ancestral jobs and job IDs of all children jobs.

In detail, the job information shown in FIG. 48 will be described. In FIG. 48, job information 167, and job related information 169 are shown. The job information 166 is the job information of the job 4 shown in FIG. 31.

The job related information 169 includes items of “job ID of root job”, “job ID of parent job”, and “job ID of child job” having values “1”, “2”, and “7”, respectively. The root job of the job 4 is the job 1, the parent job of the job 4 is the job 2, and the child job of the job 4 is the job 7.

By using the above-described job related information, the job management module 26 can create the job structure table by simply obtaining information concerning the end jobs. Moreover, since each program for the application layer 5, the service layer 7, and the handler layer 9 simply adds the job ID of the parent job to the job related information of the parent job, it is possible to easily to create the job related information when a job is generated. Furthermore, if the item of the job ID of the child job has no value, the job is the end job. Thus, the search for the end jobs can be conducted by simply checking whether or not the item of the job ID of the child job has a value. If the item has no value, a substantial value is not input in the item. For example, a value such as null or 0xffff, which may be used for a programming design, can be used as “no value”. It should be noted that a module generating a job is needed to notify the job ID of the child job to a module by which the parent job is generated.

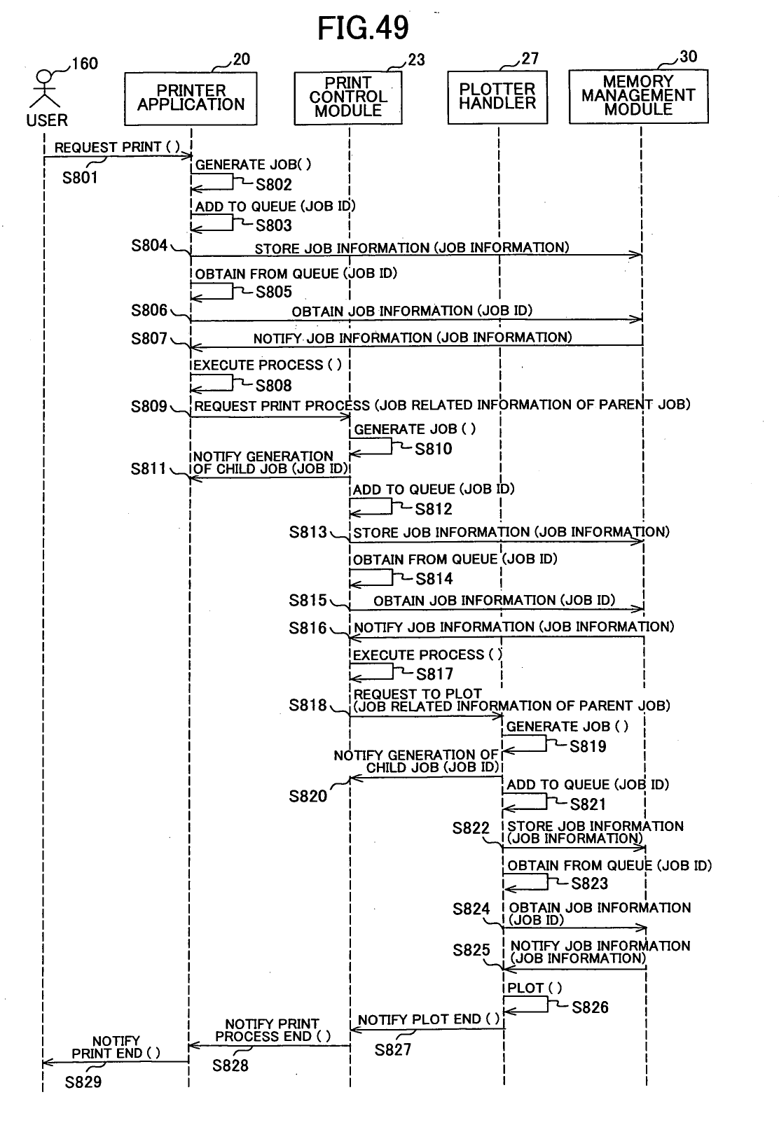

An operation sequence flow when a job is registered in the case of the fifth example of the job related information described above will be described in accordance with a sequence flow shown in FIG. 49. This sequence flow in FIG. 49 is partially different from the sequence flow shown in FIG. 34, and only different parts will be described. Steps S801, S802, S803, S804, S805, S806, S807, S808, and S810 in FIG. 49 correspond to steps S101, S102, S103, S104, S105, S106, S107, S108, and S110 in FIG. 34. Also, steps S812, S813, S814, S815, S816, and S817 in FIG. 49 correspond to steps S111, S112, S113, S114, S115, and S116 in FIG. 34. Moreover, steps S821, S822, S823, S824, S825, S826, S827, S828, and S829 in FIG. 49 correspond to steps S119, S120, S121, S122, S123, S124, S125, S126, and S127 in FIG. 34.

Step S809 in FIG. 49 corresponds to step S109 in FIG. 34, but only the job related information of the parent job is sent to the print control module 23. Moreover, after a job is generated in step S810, a process for notifying child job generation to the printer application 20 is added as step S811.

Moreover, at a request to plot in step S818, only the job related information of parent job is sent to the plotter handler 27. Furthermore, after a job is generated in step S819, generation of a child job is notified from the plotter handler 27 to the print control module 23 in step S820.

An operation sequence flow when a job is referred to is the same as the operation sequence flow in FIG. 35, and the explanation thereof will be omitted.

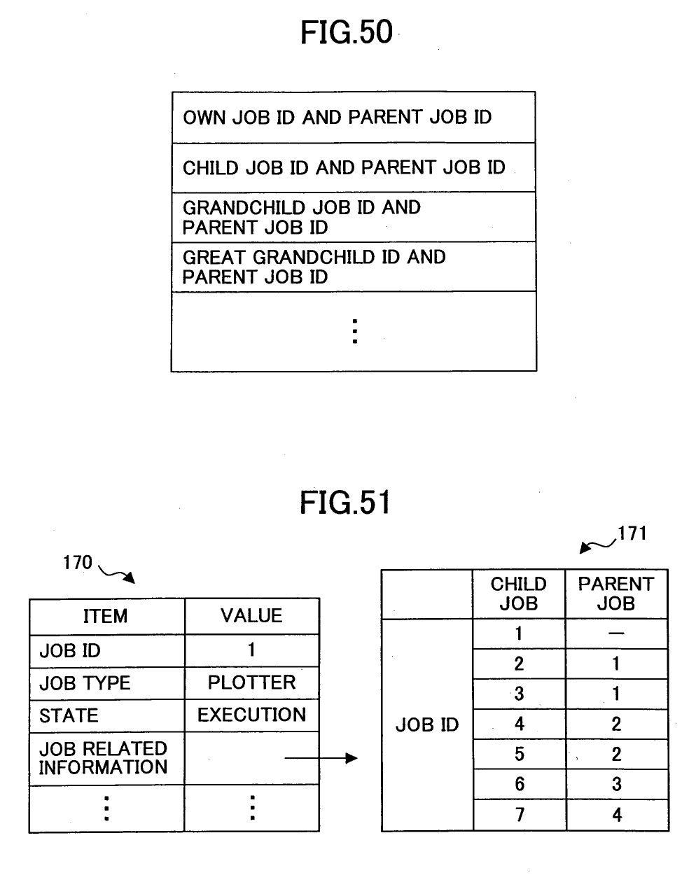

Next, a sixth example of the job related information combining the second example and the third example of the job related information will be described with reference to FIG. 50. The job related information shown in FIG. 50 includes the job ID of the parent job and the job IDs of all descendant jobs.

In detail, the job information shown in FIG. 51 will be described. In FIG. 51, job information 170 and job related information 171 are shown. The job information 170 is the job information of the job 1 shown in FIG. 31.

The job related information 171 includes items of “child job” and “parent job”. The job ID of the parent job of the job ID shown in “child job” is shown in “parent job”.

Since the job 1 is the root job, there is no parent job, the parent job of the jobs 2 and 3 are the same job 1, the parent job of the jobs 4 and 5 are the same job 2, the parent job of the job 6 is the job 3, the parent job of the job 7 is the job 4.

In the sixth example of the job related information, it is possible to create the job structure table by simply obtaining information concerning the root job. It should be noted that the job related information of the root job has no value as the job ID of the parent jobs, and then, it is possible to determine whether or not the job is the root job.

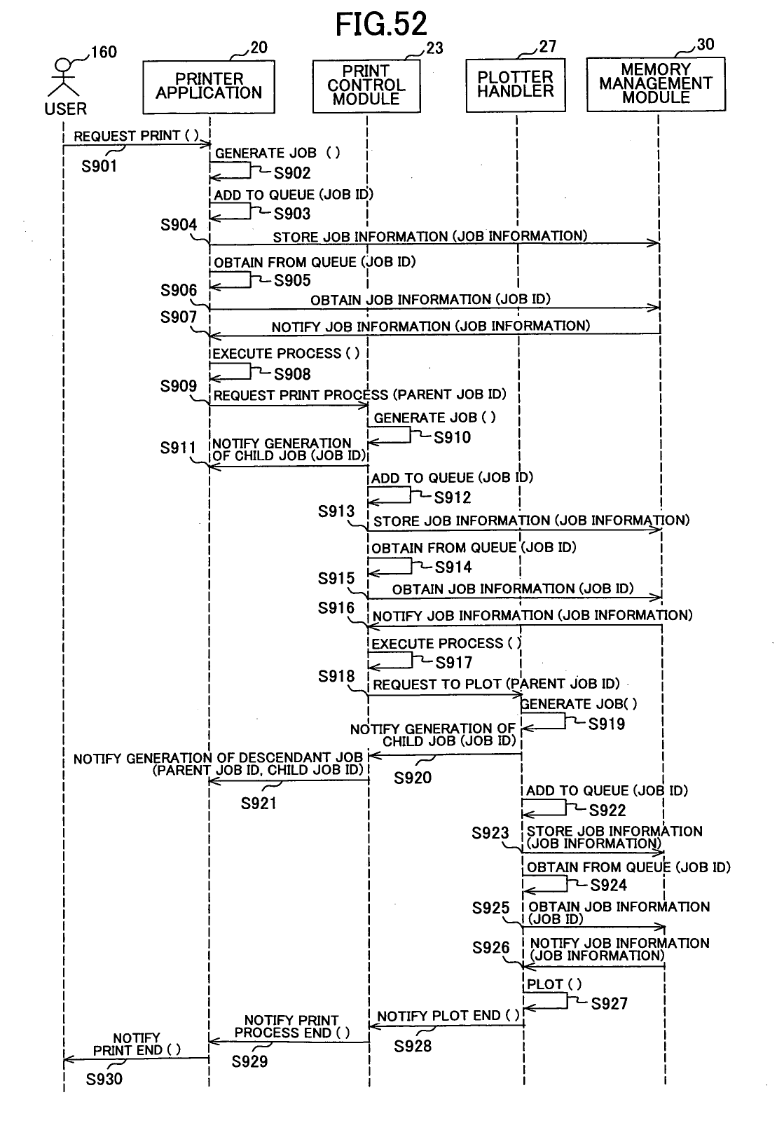

An operation sequence flow when a job is registered in the case of the sixth example of the job related information described above will be described in accordance with a sequence flow shown in FIG. 52. This sequence flow in FIG. 52 is partially different from the sequence flow shown in FIG. 34, and only different parts will be described.

Steps S901, S902, S903, S904, S905, S906, S907, and S908 in FIG. 52 correspond to steps S101, S102, S103, S104, S105, S106, S107, and S108 in FIG. 34. Also, step S912, S913, S914, S915, S916, and S917 in FIG. 52 correspond to steps S111, S112, S113, S114, S115, and S116 in FIG. 34. Moreover, steps S922, S923, S924, S925, S926, S927, S928, S929, and S930 in FIG. 52 correspond to steps S119, S120, S121, S122, S123, S124, S125, S126, and S127 in FIG. 34.

Step S909 in FIG. 52 corresponds to step S109 in FIG. 34, but only job ID of the parent job is sent to the print control module 23. Moreover, after a job is generated in step S910, a process for notifying generation of a child job to the printer application 20 is added as step S911. In addition, step S918 in FIG. 52 corresponds to step S117 in FIG. 34, but only the job ID of the parent job is sent to the plotter handler 27. Furthermore, after generation of a child job is notified to the print control module 23 in step S920, a process for notifying generation of a descendant job to the printer application 20 is added as step S921.

An operation sequence flow when a job is referred to is the same as the operation sequence flow in FIG. 43, and the explanation thereof will be omitted.

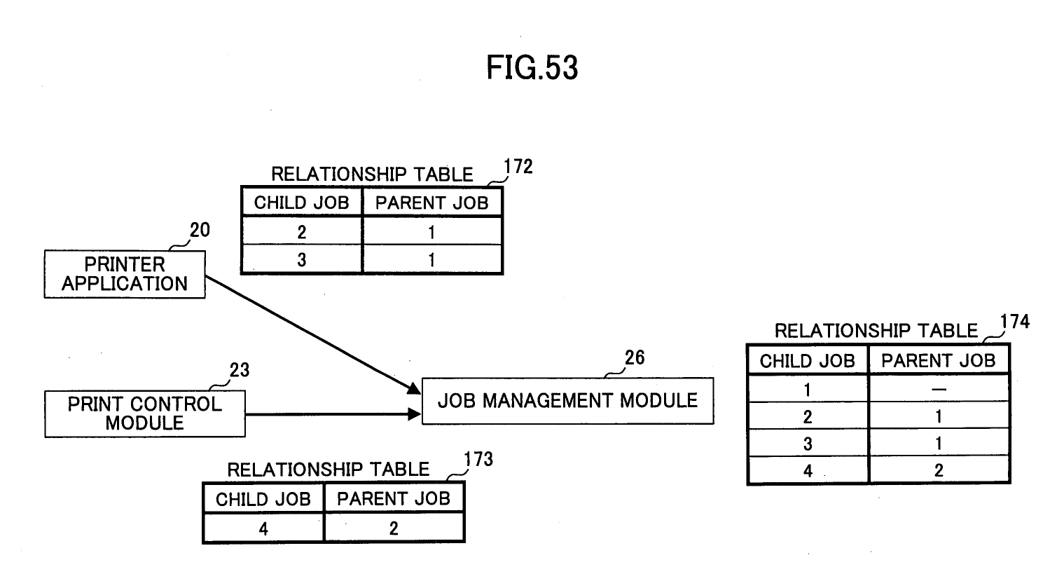

Next, a seventh example of the job related information, which is centralized and managed by the job management module 2, will be described with reference to FIG. 53.

Each module notifies a relationship between the job ID of a child job and the job ID of the parent job to the job management module 26 when the child job is generated in a process of each module, so that the example of the job related information is generated. The job management module 26 maintains relationships of all jobs, and notifies information concerning the job structure to the display application 32 when the display application 32 displays the job structure.

In FIG. 53, relationship tables 172, 173, and 174, the printer application 20, the print control module 23, and the job management module 26 are shown.

The relationship table 172 shows a relationship of jobs generated by the printer application 20. The relationship table 173 shows a relationship of jobs generated by the print control module 23. The relationship table 174 shows a relationship generated by the job management module 26 based the relationships 172 and 173.

The relationship of jobs shown in the relationship table 172 and the relationship of jobs shown in the relationship table 173 are reflected in the relationship table 174. In this case, the job information is not required to have the job related information.

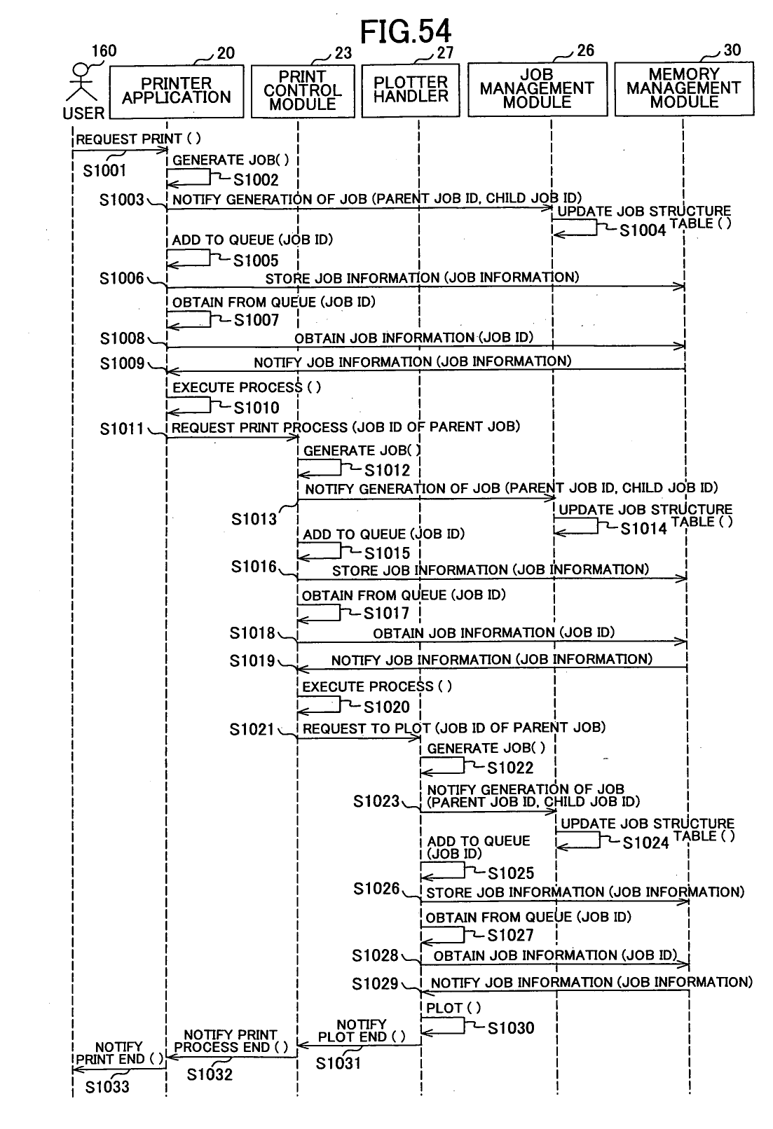

An operation sequence when a job is registered in a case of the seventh example of the job related information described above will be described in accordance with a sequence flow in FIG. 54. The sequence flow in FIG. 54 is partially different from the sequence flow shown in FIG. 34, and the different parts will be described.

Steps S1001 in FIG. 54 corresponds to step S101 in FIG. 34. Also, steps S1005, S1006, S1007, S1008, S1009, and S1010 in FIG. 54 correspond to steps S103, S104, S105, S106, S107, and S108 in FIG. 34. Moreover, step S1012 in FIG. 54 corresponds to step S110 in FIG. 34. Furthermore, steps S1015, S1016, S1017, S1018, S1019, and S1020 in FIG. 54 correspond to steps S111, S112, S113, S114, S115, and S116 in FIG. 34. Also, steps S1025, S1026, S1027, S1028, S1029, S1030, S1031, S1032, and S1033 in FIG. 54 correspond to steps S119, S120, S121, S122, S123, S124, S125, S126, and S127 in FIG. 34.

After the printer application 20 generates a job in step S1002, steps S1003 and S1004 are added. In step S1003, the printer application 20 notifies generation of a job to the job management module 26. In this step, the job ID of the parent job and the job ID of the child job are also sent to the job management module 26. Moreover, in step S1004, the job structure table is updated by the job management module 26.

Step S1011 corresponds to step S109 in FIG. 34, but only the job ID of the parent job is sent the print control module 23.

After the print control module 23 generates a job in step S1012, steps S1013 and S1014 are added. In step S1013, the print control module 23 notifies generation of a job to the job management module 26. In this step, the job ID of the parent job and the job ID of the child job are also sent to the job management module 26. Moreover, in step S1014, the job management module 26 updates the job structure table.

Step S1021 corresponds to step S117, but only the job ID of the parent job is sent to the plotter handler 27.

After the plotter handler 27 generates a job in step S1022, steps S1023 and S1024 are added. In step S1023, the plotter handler 27 notifies generation of job to the job management module 26. In this step, the job ID of the parent and the job ID of the child job are also sent to the job management module 26. Moreover, in step S1024, the job management module 26 updates the job management table.

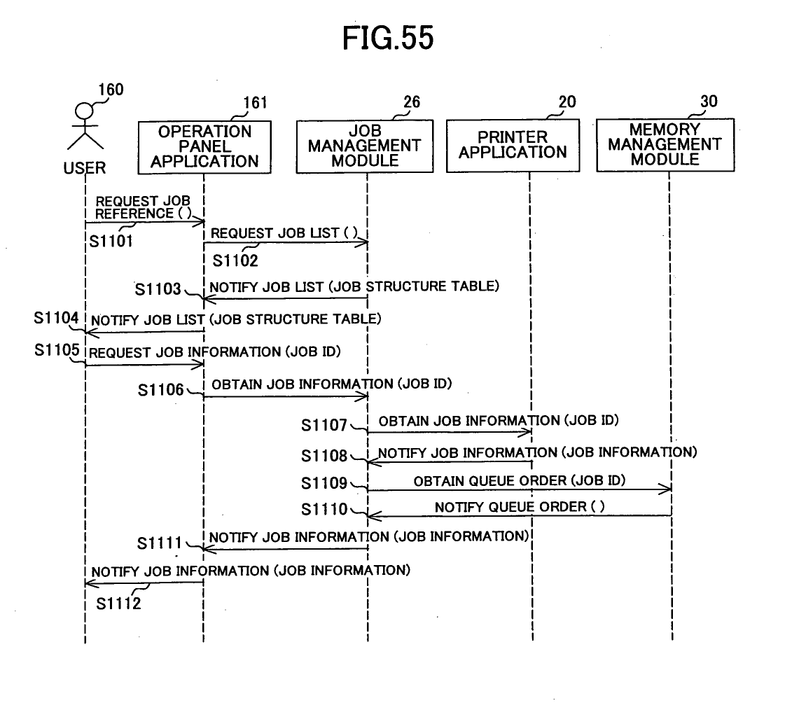

Next, referring to FIG. 55, an operation sequence flow when a job is referred to will be described. In FIG. 55, processes conducted among the user 160, the operation panel application 161, the job management module 26, the printer application 20, and the memory management module 30 are shown.

In step S1101, the operation panel application 161 receives a request of job reference from the user 160. The operation panel application 161 requests a job list to the job management module 26 in step S1102. The job management module 26 notifies the job list to the operation panel application 161 in step S1103. The operation panel application 161 notifies (displays) the job list to the user 160 in step S1104. The operation panel application 161 receives a request of the job information from the user 160 in step S1105. The operation panel 161 requests the job management module 26 to obtain the job information in step S1106.

The job management module 26 requests the memory management module 30 to obtain the job information in step S1107. The memory management module 30 notifies the job information to the job management module 26 in step S1108.

The job management module 26 requests the printer application 20 to obtain an order of queue in step S1109. The printer application 20 notifies the order of queue to the job management module 26 in step S1110. The job management module 26 notifies the job information to the operation panel application 161 in step S1111. The operation application 161 notifies (displays) the job information to the user 160 in step S1112.

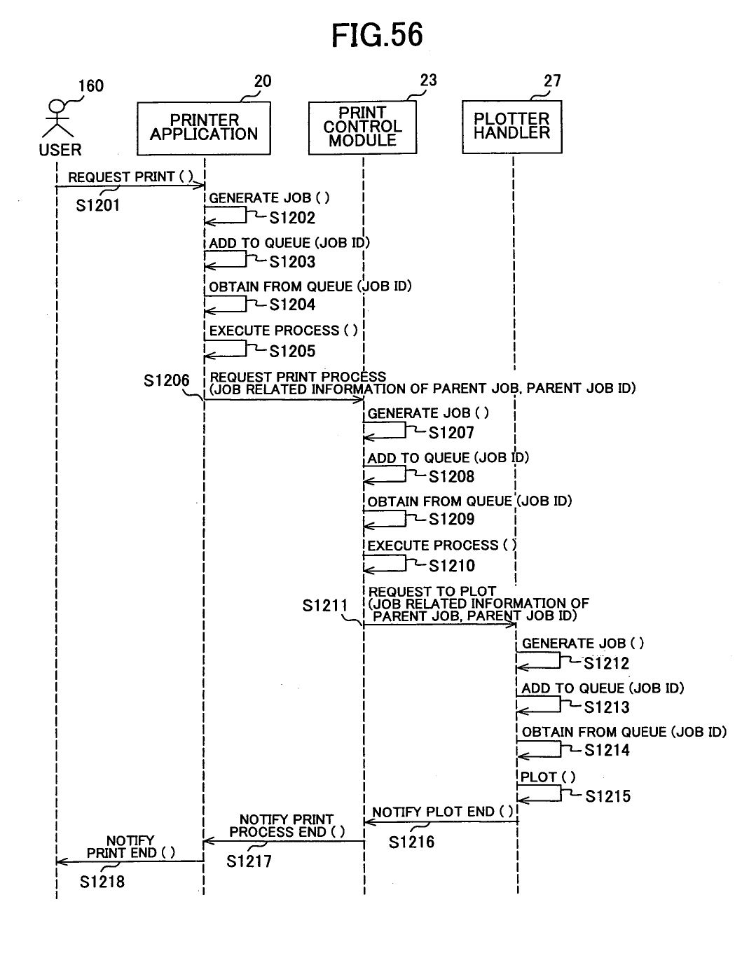

Next, processes in a case of the configuration of the software described in FIG. 30 and the job related information shown in FIG. 32 will be described. In the configuration in FIG. 30, each module in the application layer 5 and the service layer 7 maintains the job information in its own memory space. An operation sequence flow when a job is registered in this configuration in FIG. 30 will be described with reference to FIG. 56.

In FIG. 56, processes conduced among the user 160, the printer application 20, the print control module 23, and the plotter handler 27 are shown.

In step S1201, the printer application 20 receives a request to print out from the user 160. The printer application 20 generates a job in step S1202, and adds a job ID to a queue in step S1203. The printer application 20 obtains the job ID from the queue in step S1204, and executes a process in step S1205.

The printer application 20 requests a print process to the print control module 23 in step S1206. In this step, the job related information of the parent job and the job ID of the parent job are also sent to the print control module 23. The print module 23 generates a job in step S1207, and adds a job ID to queue in step S1208. Subsequently, the print control module 23 obtains the job ID from the queue in step S1209, and executes a process in step S1210.

The print control module 23 requests the plotter handler 27 to plot in step S1211. In this step, the job related information of the parent job and the job ID of the parent job are also sent to the plotter handler 27.

The plotter handler 27 generates a job in step S1212. The plotter handler 27 adds a job ID to a queue in step S1213, and obtains the job ID from the queue in step S1214.

The plotter handler 27 executes a plotting process in step S1215. The plotter handler 27 notifies a plot end to the print control module 23 in step S1216. The print control module 23 notifies a print process end to the printer application 20 in step S1217. The printer application 20 notifies (displays) a print end to the user 160 in step S1218.

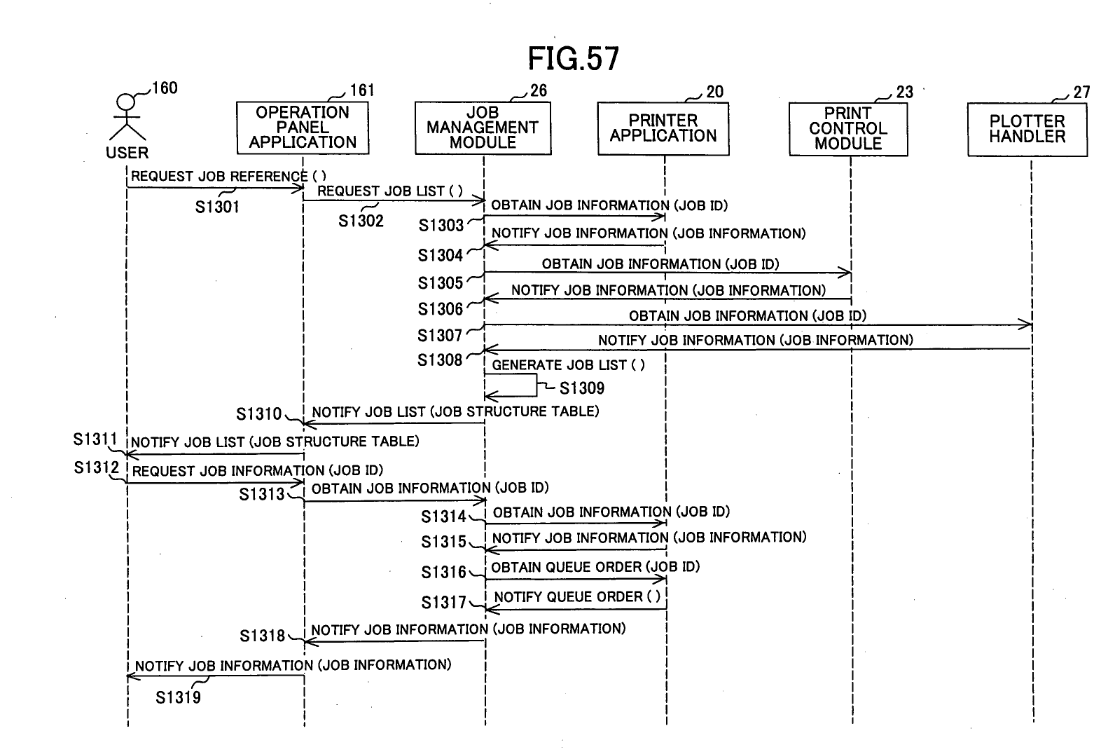

Next, referring to FIG. 57, an operation sequence when a job is referred to will be described. In FIG. 57, processes conducted among the user 160, the operation panel application 161, the job management module 26, the printer application 20, the print control module 23, the plotter handler 27 are shown.

In step S1301, the operation application 161 receives a request of a job reference from the user 160. The operation panel application 161 requests a job list to the job management module 26 in step S1302.

The job management module 26 requests the printer application 20 to obtain the job information in step S1303. The printer application 20 notifies the job information to the job management module 26 in step S1304.

The job management module 26 requests the print control module 23 to obtain the job information in step S1305. The print control module 23 notifies the job information to the job management module 26 in step S1306.

The job management module 26 requests the plotter handler 27 to obtain the job information in step S1307. The plotter handler 27 notifies the job information to the job management module 26 in step S1308.

The job management module 26 creates a job list in step S1309. The job management module 26 notifies the job list to the operation panel application 161 in step S1310. The operation panel application 161 notifies (displays) the job list to the user 160 in step S1311.

The operation panel application 161 receives a request of the job information from the user 160 in step S1312. The operation panel application 161 requests the job management module 26 to obtain the job information in step S1313. The job management module 26 requests the printer application 20 to obtain the job information in step S1314. The printer application 20 notifies the job information to the job management module 26 in step S1315.

The job management module 26 requests the printer application 20 to obtain an order of queue in step S1316. The printer application 20 notifies the order of the queue to the job management module 26 in step S1317. The job management module 26 notifies the job information to the operation panel application 161 in step S1318. The operation panel application 161 notifies (displays) the job information to the user 160 in step S1319.

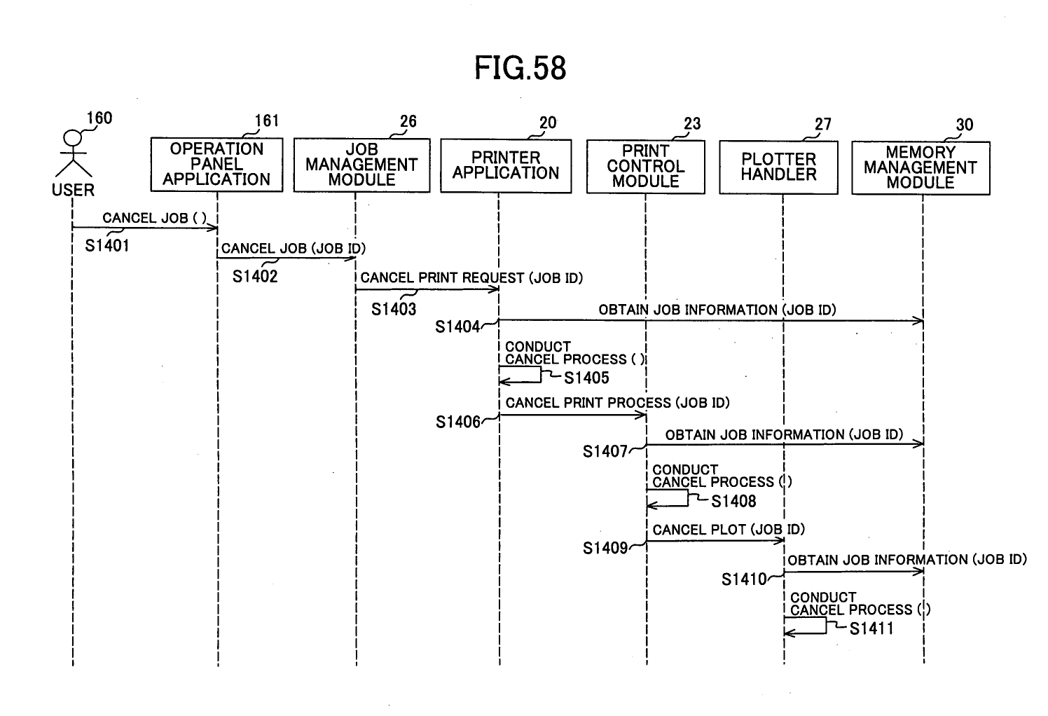

Next, referring to FIG. 58, a case in that a job is cancelled by the user will be described. In step S1401, the operation panel application 161 receives a cancel of a job from the user 160. The operation panel application 161 notifies a cancel of the job to the job management module 26 in step S1402. The job management module 26 notifies a cancel of a print request to the printer application 20 in step S1403.

The printer application 20 requests the memory management module 30 to obtain the job information in step S1404, and conducts a cancel process in step S1405. The printer application 20 notifies a cancel of a print process to the print control module 23 in step S1406.

The print control module 23 requests the memory management module 30 to obtain the job information in step S1407, and conducts a cancel process in step S1408. The print control module 23 notifies the plotter handler 27 to cancel a plotting process in step S1409. The plotter handler 27 requests the memory management module 30 to obtain the job information in step S1410, and conducts a cancel process in step S1411.

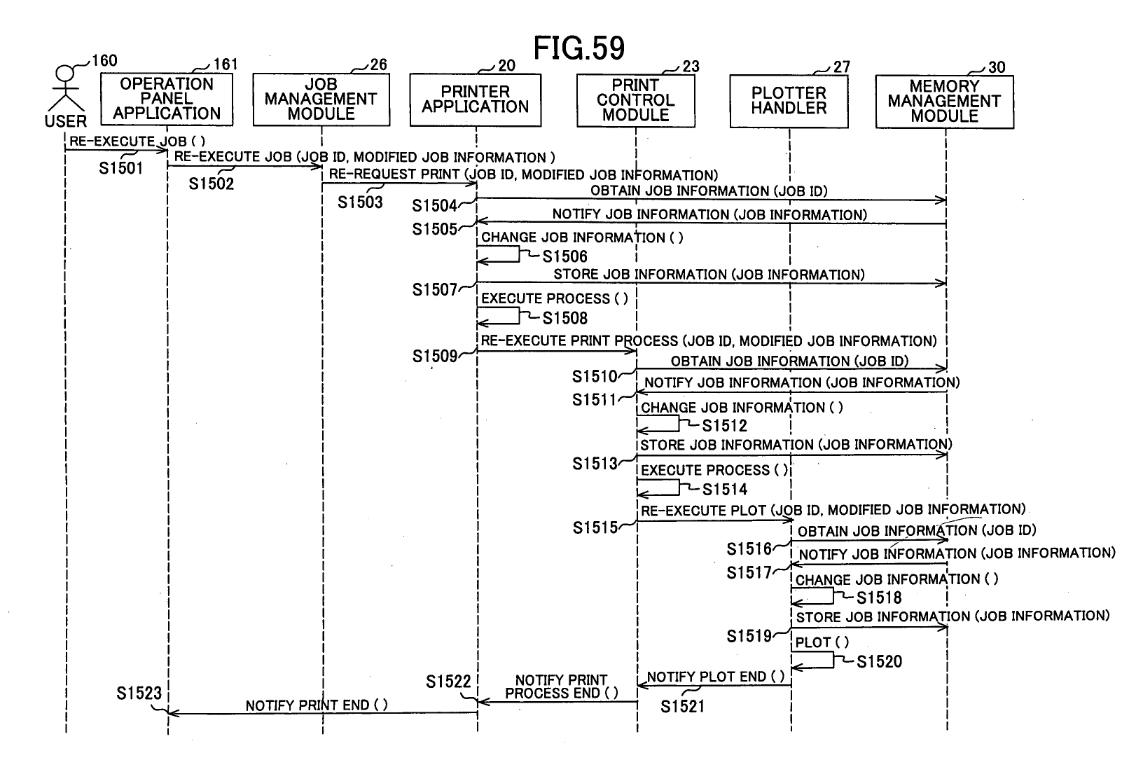

Next, referring to FIG. 59, processes in a case in that the user requests to re-execute a job will be described. In step S1501, the operation panel application 161 receives a re-execution of a job from the user 160. The operation panel application 161 notifies the re-execution of the job to the job management module 26 in step S1502. The job management module 26 notifies a print re-execution to the printer application 20 in step S1503. The printer application 20 requests the memory management module 30 to obtain the job information in step S1504. The memory management module 30 notifies the job information to the printer application 20 in step S1505.

The printer application 20 changes the job information in step S1506, and stores the job information by notifying the job information to the memory management module 30 in step S1507. The printer application 20 executes a process in step S1508.

The printer application 20 notifies a re-execution of a print process to the print control module 23 in step S1509. The print control module 23 requests the memory management module 30 to obtain the job information in step S1510. The memory management module 30 notifies the job information to the print control module 23 in step S1511. The print control module 23 changes the job information in step S1512, and stores the job information by notifying the job information to the memory management module 30 in step S1513. The print control module 23 executes a process in step S1514.

The print control module 23 notifies a re-execution to plot to the plotter handler 27 in step S1515. The plotter handler 27 requests the memory management module 30 to obtain the job information in step S1516. The memory management module 30 notifies the job information to the print control module 23 in step S1517. The print control module 23 changes the job information in step S1518, and stores the job information by notifying the job information to the memory management module 30 in step S1519. The plotter handler 27 executes a plotting process in step S1520.

The plotter handler 27 notifies a plot end to the print control module 23 in step S1521. The print control module 23 notifies a print process end to the printer application 20 in step S1522. The printer application 20 notifies a print end to the operation panel application 161 in step S1523.

The processes in the MFP are described above. Next, cooperation of the MFP and a user interface (hereinafter, called UI) will be described. For example, in the cooperation of two MFPs capable of communicating with each other, the two MFPs execute a plurality of jobs generated from a single root job by mutually cooperating with each other, so that one MFP prints out a color page and another MFP prints out a black and white page.

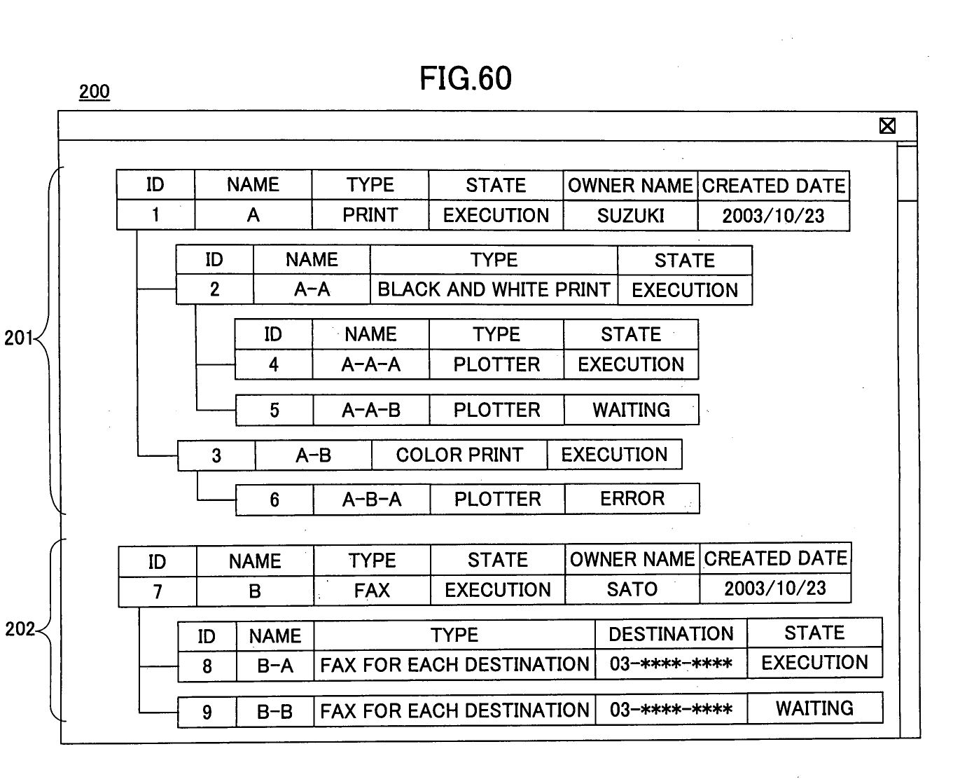

First, the UI will be described. In FIG. 60, a UI 200 displayed on a screen of the operation panel 53 or a personal computer is shown. As shown in FIG. 60, the UI 200 is a user interface for displaying the job information and the job structure of the job simultaneously. As shown in FIG. 60, the UI 200 shows relationships among jobs as a tree structure.

The UI 200 shows two job structures 201 and 202. The job structure 201 shows jobs having job IDs “1” through “6”, and the job structure 202 shows jobs having job IDs “7” through “9”. In these jobs, the job 1 and the job 7 are the root job, and the jobs 4, 5, 6, 8, and 9 are the end jobs.

Moreover, the UI 200 shows the job information described in FIG. 20 and FIG. 21. As shown in FIG. 60, the job information includes a type, a state, an owner name, and a like, so as to easily understand each set of the job information.

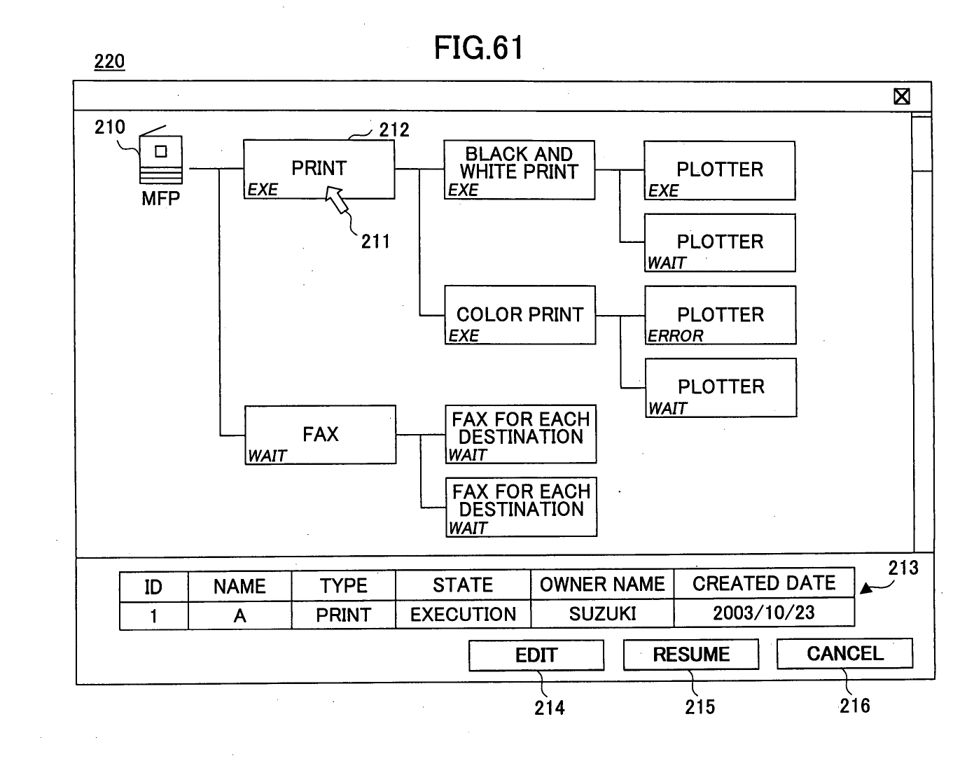

Next, referring to FIG. 61, another UI will be described. A UI 220 shown in FIG. 61 shows the job structure of jobs of an MFP 210. At the UI 220, when a job is selected, information concerning the selected job is displayed.

In FIG. 61, a print job 212 is selected by a cursor 211, job information 213 of the print job 212 is displayed at a lower display area. Moreover, at the UI 220, it is possible to edit the job information, resume a job, and cancel a job. The job information can be edited by clicking an edit button 214, a job can be resumed by clicking a resume button 215, and a job can be canceled by clicking a cancel button 216. It should be noted that “edit” means to edit the job information, “resume” means to re-start an execution the job being stopped, and “cancel” means to cancel an execution of a job.

As described above, the UI 200 and the UI 220 shows the job structure of jobs and the job information so as to easily understand them.

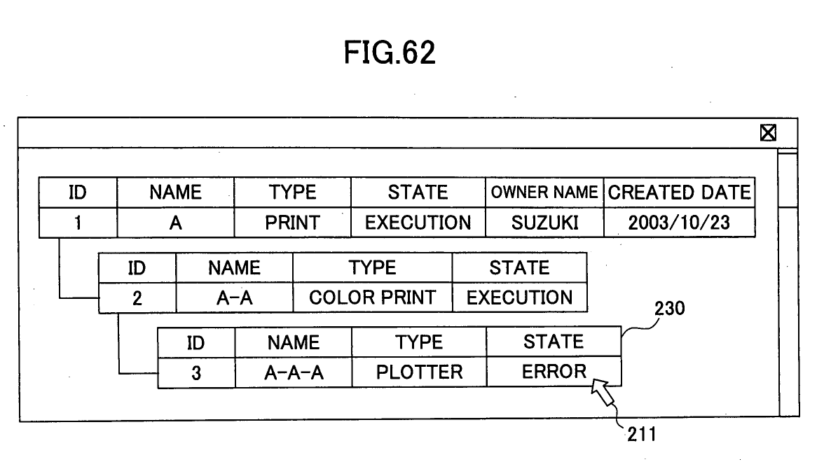

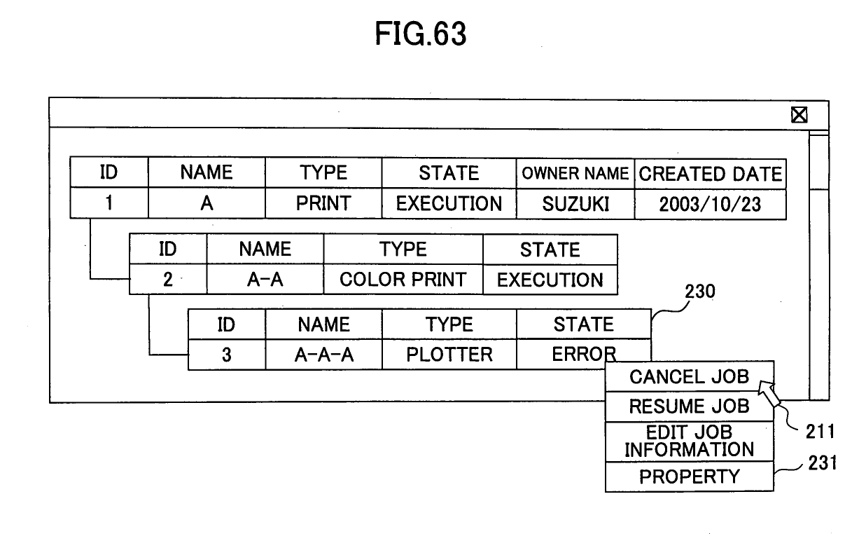

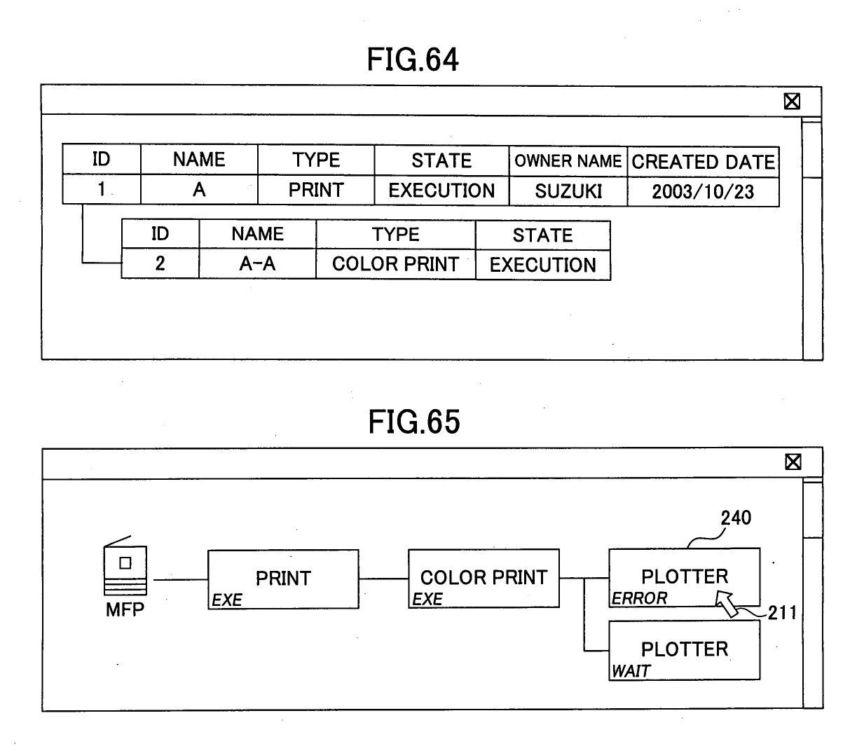

Next, referring to the UI 200 and the UI 220 described above, a user interface in a case of actually canceling an execution of a job will be described. First, a case of the UI 200 will be described with reference to FIG. 62, FIG. 63, and FIG. 64. In FIG. 62, the job 3 in which an error occurs is shown. A user, who attempts to cancel an execution of a process of the job 3, positions a cursor 211 at the job information 230 of the job 3. For example, the user clicks a right side of a mouse.

By clicking the right side of the mouse, an UI shown in FIG. 63 is displayed. As shown in FIG. 63, this UI includes a menu 231 listing operation items executable with respect to the job 3. The menu 231 displays “cancel job”, “resume job”, “edit job information”, and “property”. In this case, for example, the user positions the cursor 221 at “cancel job” in the menu 231, and clicks a left side of the mouse.

In response to this click, the execution of the process of the job 3 is canceled, and the job 3 is not displayed as shown in FIG. 64.

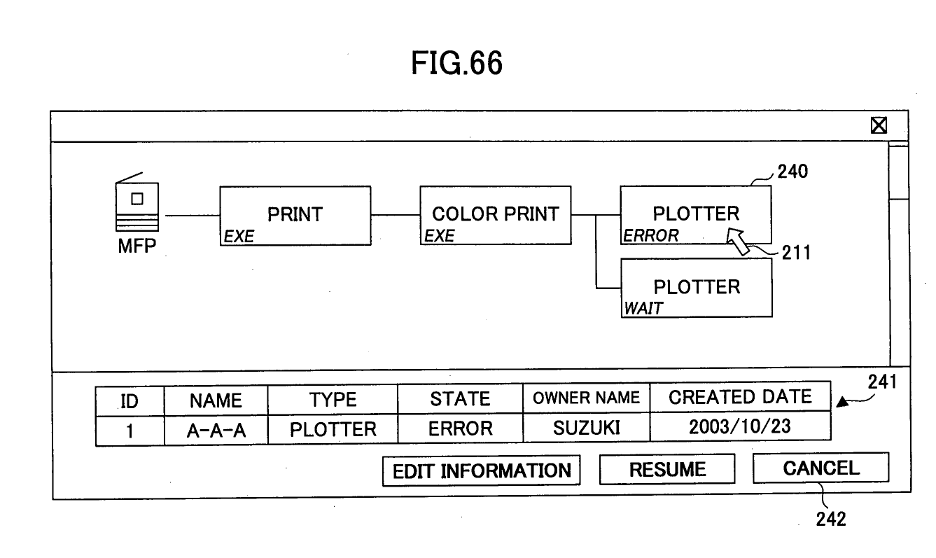

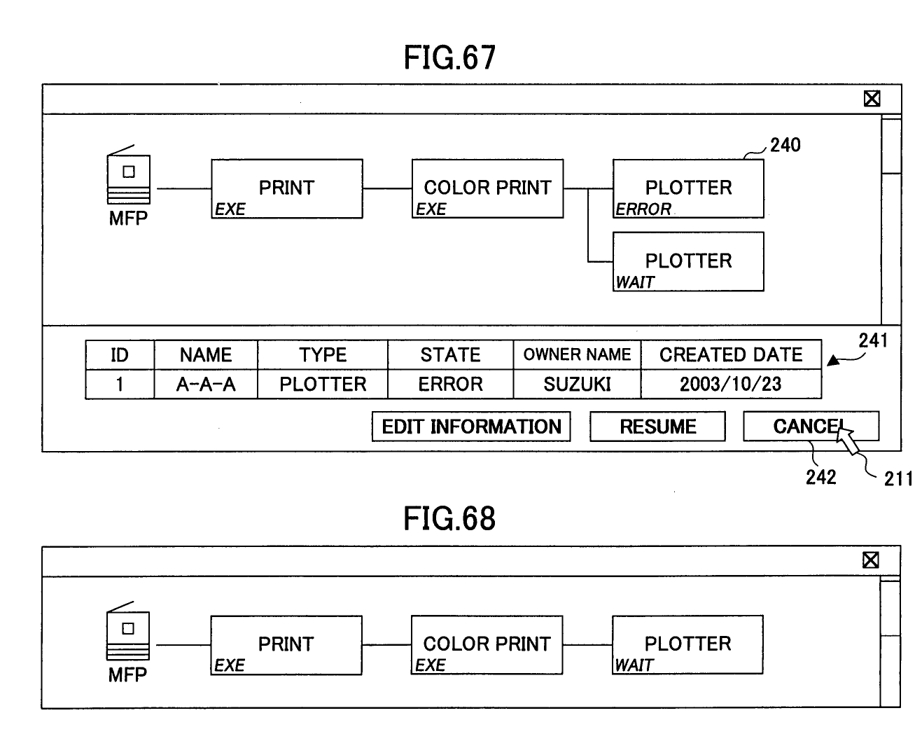

Next, a case of the UI 220 will be described with reference to FIG. 65, FIG. 66, FIG. 67, and FIG. 68. FIG. 65 shows a plotter job 24 in which an error occurs. A user, who attempts to cancel an execution of a process of the plotter job 240, positions the cursor 211 at the plotter job 240, and for example, the user clicks a left side of a mouse.

As shown in FIG. 66, in response to this click, job information 241, a cancel button 242, and a like are displayed. Then, as shown in FIG. 67, the user, who attempts to cancel the execution of the process of the plotter job 240, positions the cursor 211 at the cancel button 242, and for example, the user clicks the left side of the mouse.

In response to this operation, the execution of the process of the plotter job 240 is cancelled, and then the plotter job 240 is not displayed as shown in FIG. 68.

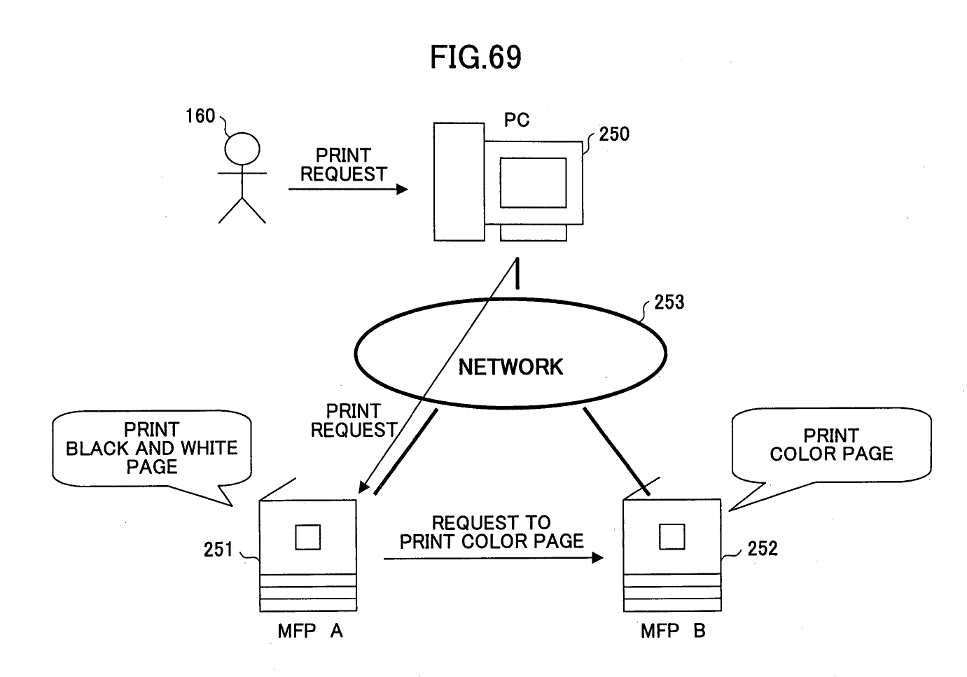

Next, a cooperation of MFPs will be described. FIG. 69 is a diagram showing the cooperation of MFPs. In FIG. 69, the user 160, a PC (Personal Computer) 250, a network 253, an MFP A 251, and an MFP B 252 are shown. The PC 250, the MFP A 251, and the MFP B 252 are connected and communicate with each other through the network 253.

In this network configuration, for example, it is assumed that the user 160 requests to print out a document including color pages and black and white pages from the PC 250 to the MFP A 251. In this case, the MFP A 251 prints out the white and black pages by itself, and also requests the MFP B 252 to print out color pages. Accordingly, the MFP B 252 prints out the color pages.

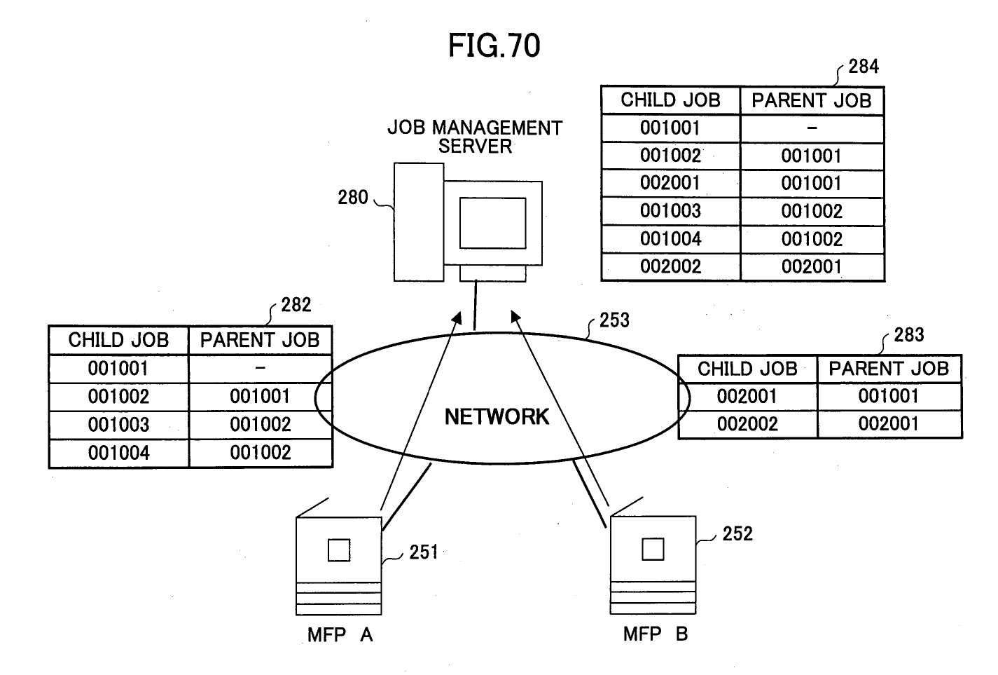

A job structure in this process is the job structure described in FIG. 10. In a case in that the job structure of jobs involves a plurality of MFPs, as shown in FIG. 70, a job management server 280 for managing jobs is provided, so that the job structure of the entire jobs through the network 253 can be managed.

In FIG. 70, two MFPs and the job management server 280 are provided in a network configuration. A job structure table 282 is a job structure table of a job executed in the MFP A 251, and a job structure table 283 is a job structure table of a job executed in the MFP B 252.

These two job structure tables 282 and 283 are sent to the job management server 280 by the MFP A 251 and MFP B 252, respectively. The job management server 280 merges the job structure tables 282 and 283 obtained from the MFP A 251 and MFP B 252, and can create a job structure table 284 of the entire jobs through the network 253. In this case, a process for obtaining the job structure table corresponds to a job structure information obtaining part. The job structure information obtaining part may be the operation panel application 161 in a case of MFP as described above, or may be an HTML (HyperText Markup Language) browser in a case of the personal computer. Also, the job information can be obtained with the job information table.

The process described above is a process to receive the job structure table and display a graphical user interface based on the job structure table.

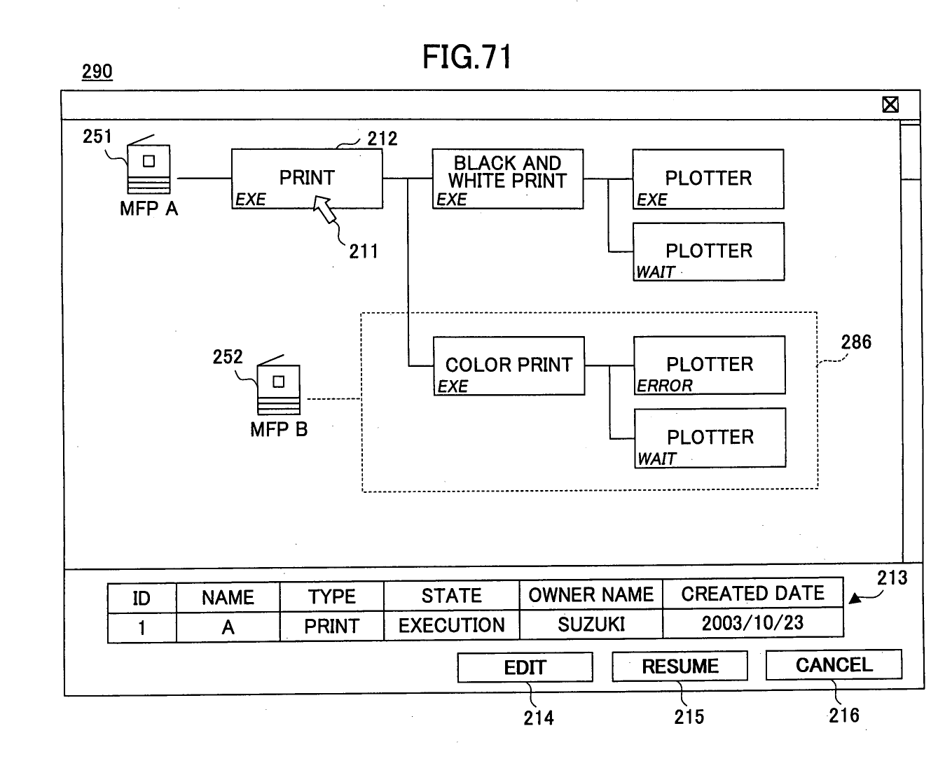

By managing job as described above, a UI 290 shown in FIG. 71 can be displayed at a management screen of the job management server 280. The UI 290 shows jobs of the MFP A 251 and the MFP B 252, the job information 213 described above, the edit button 214, the resume button 215, and the cancel button 216. The job information 213 is the job information of the print job 212 where the cursor 211 is positioned.

In order to clearly show jobs of the MFP B 252, for example, the UI 290 shows jobs of the MFP B 252 descending from the print job 212 as the root job with a dashed line 286.

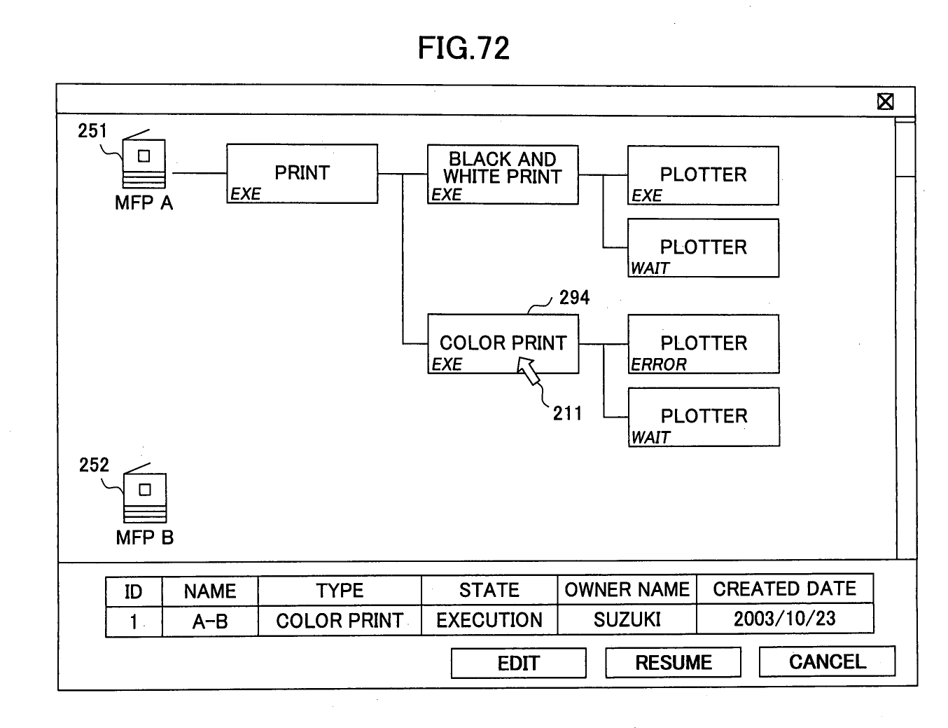

User interfaces on this UI 290 in a case of executing a job belonging to one MFP by another MFP will be described. A user interface shown in FIG. 72 displays jobs descended from the print job being executed by the MFP A 251. In these jobs, a color print job 294 is executed by the MFP B 252.

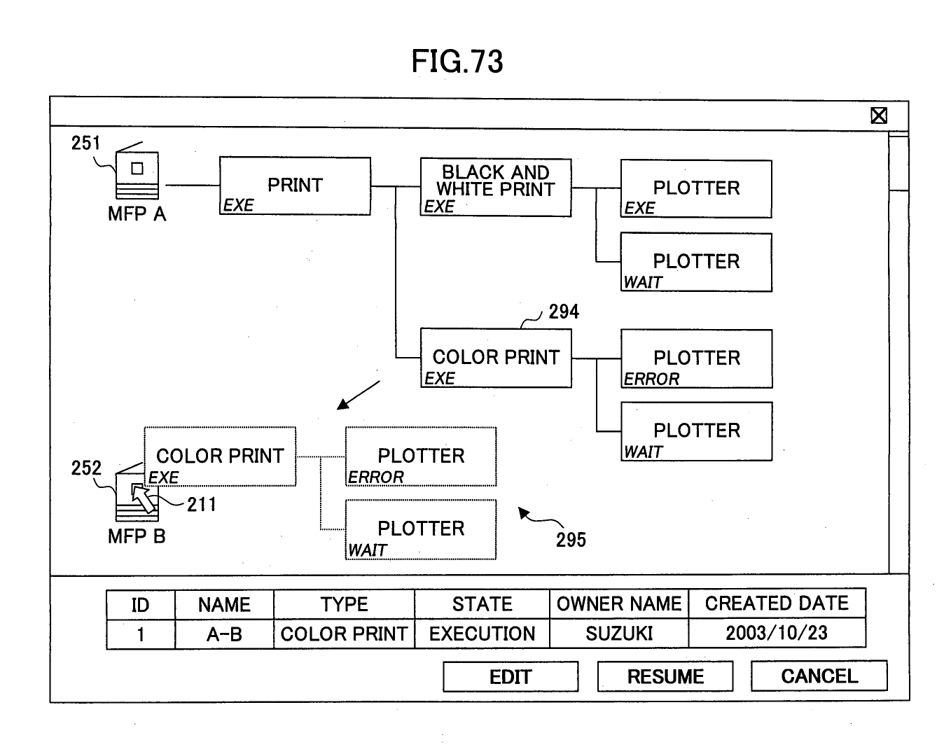

In this case, as shown in FIG. 73, the user drags the color print job 294 to an icon representing the MFP B 252 by using the cursor 211. In this case, as shown in an icon 295, when the color print job 294 is dragged, children jobs of the color print job 294 are dragged together with the color print job 294.

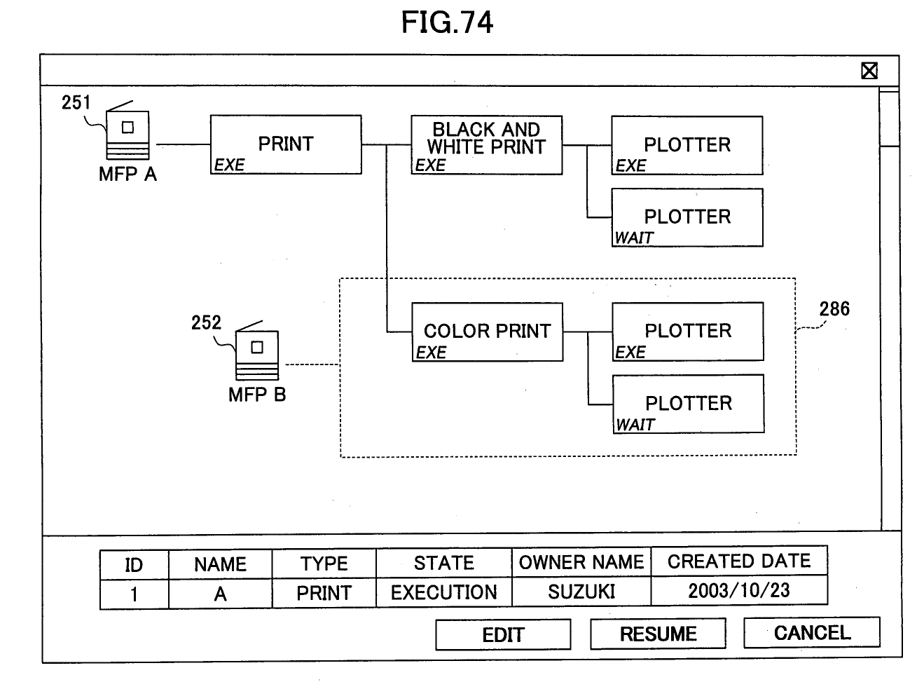

Accordingly, as shown in FIG. 74, the color print job 295 and the children jobs of the color print job 295, which are surrounded by the dashed line 286, are shown as jobs of the MFP B 252.

As described above, it is possible to change a device to which a job belongs, by an instruction of the user.

In a case of using MFPs connected with each other through the network as described above, a job occurring an error at one MFP can be processed by another MFP, so as to avoid the error.

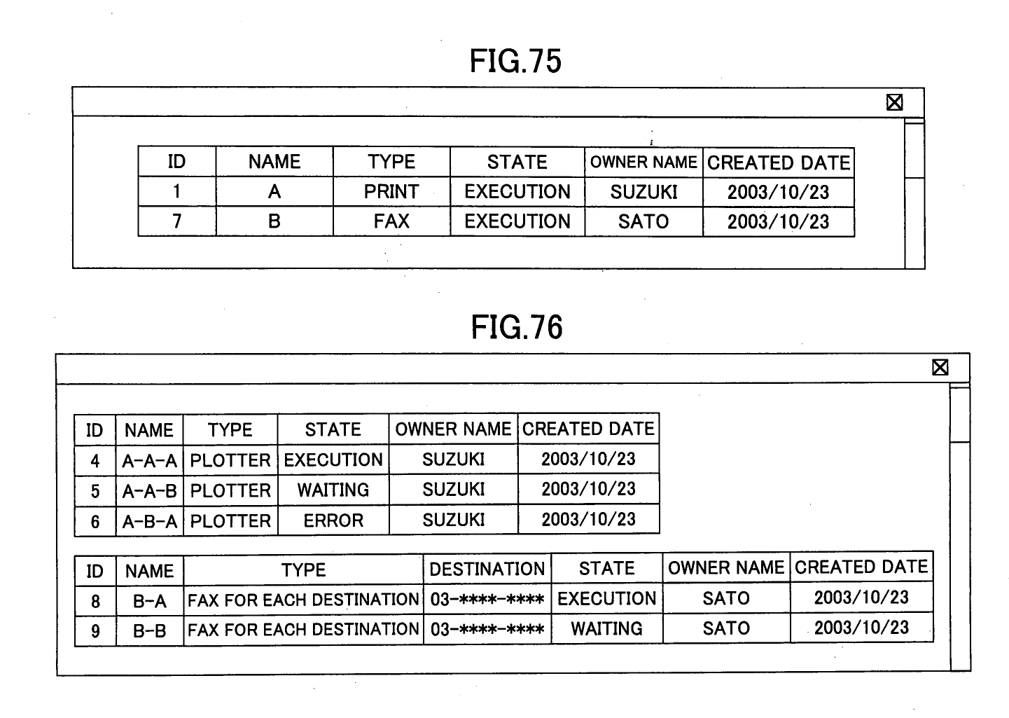

Next, various display methods for the job structure will be described. First, referring to FIG. 75, a UI for displaying only the root job will be described. The UI shown in FIG. 75 displays only the root jobs in jobs described in FIG. 60. The root jobs in the job structure shown in FIG. 60 are two jobs: the job 1 and the job 2. Accordingly, the UI shown in FIG. 75 displays the job information of the job 1 and the job 7.

Next, a UI for displaying only the end job will be described. A UI shown in FIG. 76 displays only the end jobs in jobs described in FIG. 60. The end jobs in the job structure shown in FIG. 60 are five jobs: the job 4, the job 5, the job 6, the job 8, and the job 9. Accordingly, the UI shown in FIG. 76 displays five sets of the job information.

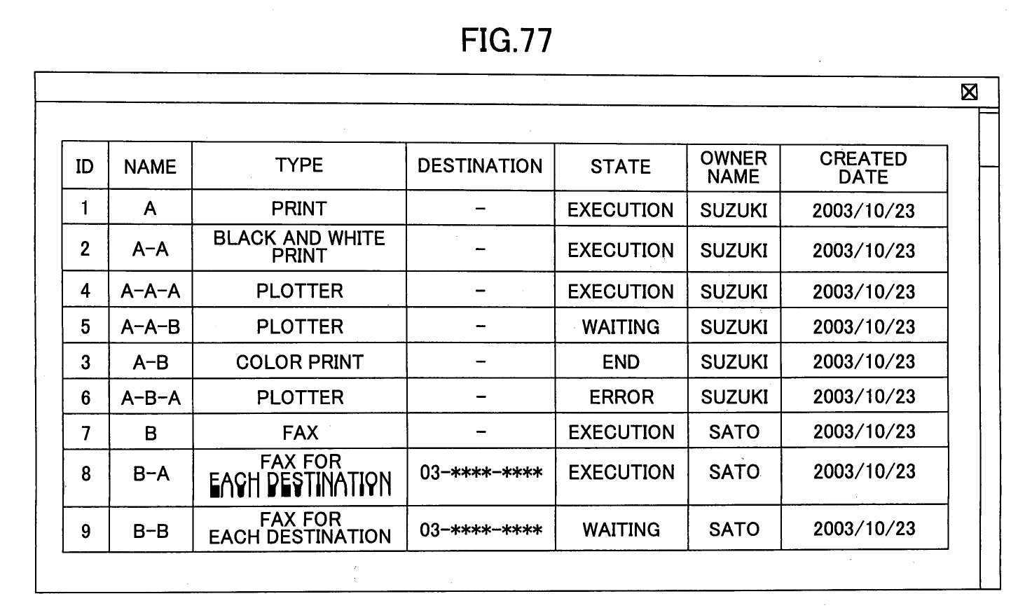

Next, a UI for displaying a job list will be described. The UI shown in FIG. 60 displays jobs in the tree structure. A UI shown in FIG. 77 displays jobs as the job list, instead of the tree structure.

The UI in FIG. 77 displays all jobs shown in FIG. 60 as the job list. By displaying the job list showing all jobs, the UI allows the user to sort by each item. For example, if the job list is sorted by the owner name, jobs requested by a specific owner can be easily recognized.

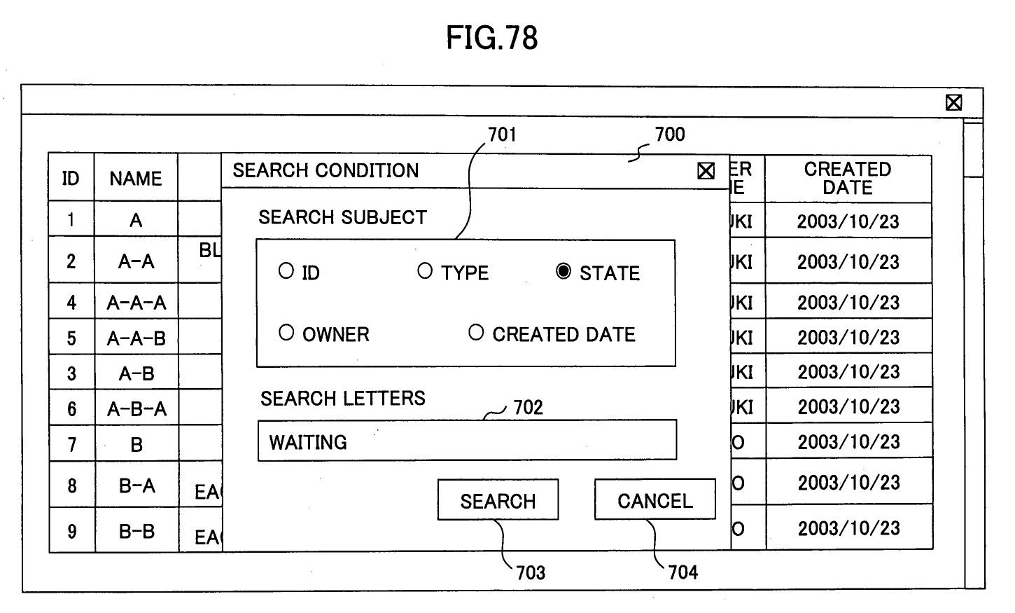

Moreover, the UI in FIG. 77 allows the user to search. A search in the UI will be described with reference to FIG. 78. In FIG. 78, a search condition screen 700, radio buttons 701 for a search subject, an input area 702 to input search letters, a search button 703, and a cancel button 704 are displayed.

The radio buttons 701 for the search subject are used to select an item of the search subject. In FIG. 78, “state” is selected as the item of the search subject. The input area 702 to input search letters is a text box to input a character string to search. In FIG. 78, the character string “waiting” is input. The search button 703 is a button to execute a search based on the character string input in the input area 702. The cancel button 704 is a button to close the search condition screen 700 without any operation.

It is possible to search for a job as a subject by using the search condition screen 700, since the job structure table is created within the MFP.

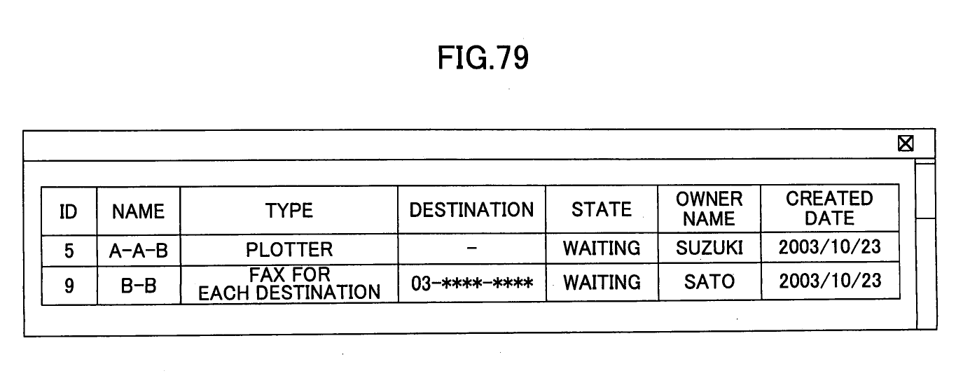

When the user clicks the search button 703, a UI showing a search result is displayed as shown in FIG. 79. Referring to FIG. 77, the job 5 and the job 9 are jobs in a waiting state. Accordingly, the job 5 and the job 9 are displayed in the UI in FIG. 79.

The present invention is not limited to the specifically disclosed embodiments, and variations and modifications may be made without departing from the scope of the present invention.

The present application is based on the Japanese Priority Applications No. 2004-064048 filed on Mar. 8, 2004, No. 2004-064049 filed on Mar. 8, 2004, No. 2005-57889 filed on Mar. 2, 2005, and No. 2005-57890 filed on Mar. 2, 2005, the entire contents of which are hereby incorporated by reference.

1. An image forming apparatus including a hardware resource used in an image forming process, and executing a job concerning an image formation, said image forming apparatus comprising:
a job related information generating part generating job related information showing a relationship between one job and each of other jobs, for each job; and
a job structure information creating part creating job structure information to search for a certain job related to an arbitrary job based on the job related information.

2. The image forming apparatus as claimed in claim 1, wherein the job related information includes identification information of all ancestral jobs of the job.

3. The image forming apparatus as claimed in claim 1, wherein the job related information includes identification information of a parent job of the job.

4. The image forming apparatus as claimed in claim 1, wherein the job related information includes identification information of all descendent jobs of the job.

5. The image forming apparatus as claimed in claim 1, wherein the job related information includes identification information of a child job of the job.

6. The image forming apparatus as claimed in claim 1, further comprising job information including the identification information and information concerning the job.

7. The image forming apparatus as claimed in claim 6, wherein the job information includes job operation permission information showing whether or not an operation with respect to the job is permitted.

8. The image forming apparatus as claimed in claim 7, wherein the job information includes job operation condition information showing a condition to permit an operation with respect to the job.

9. The image forming apparatus as claimed in claim 8, wherein the operation with respect to the job is an operation to cancel the job.

10. The image forming apparatus as claimed in claim 8, wherein the operation with respect to the job is an operation to re-execute the job.

11. The image forming apparatus as claimed in claim 8, wherein the operation with respect to the job is an operation to cancel the job.

12. The image forming apparatus as claimed in claim 8, wherein the operation with respect to the job is an operation to edit the job information.

13. The image forming apparatus as claimed in claim 8, wherein the operation with respect to the job is an operation to change a device to execute the job.

14. The image forming apparatus as claimed in claim 6, wherein the job information is created for each job.

15. The image forming apparatus as claimed in claim 14, further comprising a storage managing part storing the job information and providing the job information corresponding to the identification information.

16. The image forming apparatus as claimed in claim 15, wherein the job structure information creating part creates the job structure information by obtaining the job information from the storage managing part.

17. A job managing method for managing a job in an image forming apparatus including a hardware resource used in an image forming process, and executing a job concerning an image formation, said job managing method comprising:
generating job related information to create job structure information of the job; and
creating the job structure information based on the job related information.

18. The job managing method as claimed in claim 17, wherein the job related information includes identification information for all ancestral jobs of the job.

19. The job managing method as claimed in claim 17, wherein the job related information includes identification information of a parent job of the job.

20. The job managing method as claimed in claim 17, wherein the job related information includes identification information of all descendent jobs of the job.

21. The job managing method as claimed in claim 17, wherein the job related information includes identification information of a child job of the job.

22. The job managing method as claimed in claim 17, further comprising job information including the identification information and information concerning the job.

23. The job managing method as claimed in claim 22, wherein the job information includes job operation permission information showing whether or not an operation is permitted.

24. The job managing method as claimed in claim 23, wherein the job information includes job operation condition information showing a condition to permit an operation with respect to the job.

25. The job managing method as claimed in claim 24, wherein the operation with respect to the job is an operation to cancel the job.

26. The job managing method as claimed in claim 24, wherein the operation with respect to the job is an operation to re-execute the job.

27. The job managing method as claimed in claim 24, wherein the operation with respect to the job is an operation to cancel the job.

28. The job managing method as claimed in claim 24, wherein the operation with respect to the job is an operation to edit the job information.

29. The job managing method as claimed in claim 24, wherein the operation with respect to the job is an operation to change a device to execute the job.

30. The job managing method as claimed in claim 23, wherein the job information is created for each job.

31. The job managing method as claimed in claim 30, further comprising storing the job information and providing the job information corresponding to the identification information.

32. The job managing method as claimed in claim 31, wherein said creating the job structure information obtains the job information stored in said storing the job information, and creates the job structure information.

33. An electronic device for displaying job information concerning a job generated in a predetermined process, said electronic device comprising:
job structure information showing a relationship between an arbitrary job and each of other jobs; and
a graphical user interface displaying part displaying the job information based on the job structure information.

34. The electronic device as claimed in claim 33, wherein the graphical user interface displaying part displays the relationship by relating a device, to which the job belongs, to each of jobs.

35. The electronic devices as claimed in claim 33, wherein the graphical user interface displaying part displays the job information of all jobs.

36. The electronic device as claimed in claim 35, further comprising a job searching part searching for a job in all jobs.

37. The electronic device as claimed in claim 33, wherein the graphical user interface displaying part displays the job information of only a root job in all jobs.

38. The electronic device as claimed in claim 33, wherein the graphical user information displaying part displays the job information of only an end job in all jobs.

39. The electronic device as claimed in claim 33, wherein the graphical user interface displaying part displays the job information so as to show each relationship among all jobs.

40. The electronic device as claimed in claim 33, wherein the graphical user interface displaying part displays predetermined operation items executable with respect to each of all jobs.

41. The electronic device as claimed in claim 40, wherein the predetermined operation items includes at least one of a cancel of the job, an interruption of the job, an execution of the job, an edit of the job information, and a change of a device to execute the job.

42. The electronic device as claimed in claim 33, wherein the job information includes at least one of a type showing a process content of the job, a state of the job, identification information for identifying the job, an owner name of the job, and a created date of the job.

43. The electronic device as claimed in claim 33, wherein the job structure information is information showing a parent-child relationship of the job.

44. The electronic device as claimed in claim 33, further comprising a job structure information obtaining part obtaining the job structure information from at least one device.

45. The electronic device as claimed in claim 44, further comprising an entire job structure information creating part merging the job structure information obtained from each of devices to make a single set of the job structure information.

46. The electronic device as claimed in claim 33, wherein the job structure information is created based on job related information created for each job.

47. The electronic device as claimed in claim 46, wherein the job related information includes identification information of all ancestral jobs of the job.

48. The electronic device as claimed in claim 46, wherein the job related information includes identification information of a parent job of the job.

49. The electronic device as claimed in claim 46, wherein the job related information includes identification information of all descendent jobs of the job.

50. The electronic device as claimed in claim 46, wherein the job related information includes identification information of a child job of the job.

51. The electronic device as claimed in claim 33, further comprising:
a hardware resource used in an image forming process; and
a computer-executable program causing the electronic device to conduct a process concerning an image formation.

52. The electronic device as claimed in claim 51, wherein in response to a notice from the graphical user interface displaying part, a job, which belongs to another device, is executed.

53. The electronic device as claimed in claim 51, wherein in response to a notice from the graphical user interface displaying part, a job to be executed by another device is executed.

54. A job displaying method for displaying job information concerning a job generated in a predetermined process, said job displaying method comprising:
receiving job structure information showing a relationship between an arbitrary job and each of other jobs; and
displaying the job information based on the job structure information.

55. The job displaying method as claimed in claim 54, wherein the graphical user interface displaying part displays the relationship by relating, a device to which the job belongs, to each of jobs.

56. The job displaying method as claimed in claim 54, wherein the graphical user interface displaying part displays the job information of all jobs.

57. The job displaying method as claimed in claim 54, wherein the graphical user interface displaying part displays the job information of only a root job in all jobs.

58. The job displaying method as claimed in claim 54, wherein the graphical user information displaying part displays the job information of only an end job in all jobs.

59. The job displaying method as claimed in claim 54, wherein the graphical user interface displaying part displays the job information so as to show each relationship among all jobs.

60. The job displaying method as claimed in claim 54, wherein the graphical user interface displaying part displays predetermined operation items executable with respect to each of all jobs.

61. The job displaying method as claimed in claim 54, wherein the predetermined operation items includes at least one of a cancel of the job, an interruption of the job, an execution of the job, an edit of the job information, and a change of a device to execute the job.

62. The job displaying method as claimed in claim 54, wherein the job information includes at least one of a type showing a process content of the job, a state of the job, identification information for identifying the job, an owner name of the job, and a created date of the job.

63. The job displaying method as claimed in claim 54, wherein the job structure information is information showing a parent-child relationship of the job.

64. The job displaying method as claimed in claim 54, further comprising obtaining the job structure information from at least one device.

65. The job displaying method as claimed in claim 54, wherein the job structure information is created based on the job related information created for each job.

66. The job displaying method as claimed in claim 65, wherein the job related information includes identification information of all ancestral jobs of the job.

67. The job displaying method as claimed in claim 65, wherein the job related information includes identification information of a parent job of the job.

68. The job displaying method as claimed in claim 65, wherein the job related information includes identification information of all descendent jobs of the job.

69. The job displaying method as claimed in claim 65, wherein the job related information includes identification information of a child job of the job.

70. A job displaying program for causing a computer to display job information concerning a job generated in a predetermined process, said job displaying program comprising the code for:
receiving job structure information showing a relationship between an arbitrary job and each of other jobs; and
displaying the job information based on the job structure information.
